(19) United States
(12) Patent Application Publication
(10) Pub. No.: US 2025/0029485 A1
(43) Pub. Date: Jan. 23, 2025

(54) TRAFFIC FLOW CONTROL APPARATUS AND TRAFFIC FLOW CONTROL PROGRAM

(71) Applicant: DENSO CORPORATION, Kariya-city (JP)

(72) Inventor: Yutaro ITO, Kariya-city (JP)

(73) Assignee: DENSO CORPORATION, Kariya-city (JP)

(21) Appl. No.: 18/776,718

(22) Filed: Jul. 18, 2024

(30) Foreign Application Priority Data
Jul. 19, 2023 (JP) 2023-117656

(51) Int. Cl. G08G 1/01; G08G 1/095

(52) U.S. Cl. CPC G08G 1/0145; G08G 1/0116; G08G 1/095

(57) ABSTRACT

A traffic flow control apparatus includes a communication unit and a control unit. The control unit acquires information related to a first controlled vehicle that communicates with the communication unit, information related to a following vehicle that travels between the first controlled vehicle and a second controlled vehicle that travels behind the first controlled vehicle and communicates with the communication unit, and information related to a traffic light that is positioned ahead of the first controlled vehicle. The control unit causes the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the traffic light.

### CROSS-REFERENCE TO RELATED APPLICATIONS

This application is based on and claims the benefit of priority from Japanese Patent Application No. 2023-117656, filed on Jul. 19, 2023. The entire disclosure of the above application is incorporated herein by reference.

### BACKGROUND

### Technical Field

The present disclosure relates to a traffic flow control apparatus and a traffic flow control program.

### Related Art

A vehicle driving assistance system is known that determines a traveling state of an own vehicle based on a distance to an intersection, a speed of the own vehicle, and traffic light information of a traffic light is known. In this vehicle driving assistance system, acceleration/deceleration control is performed on the own vehicle depending on the traveling state.

### SUMMARY

An aspect of the present disclosure provides a traffic flow control apparatus including a communication unit and a control unit. The control unit acquires information related to a first controlled vehicle that communicates with the communication unit, information related to a following vehicle that travels between the first controlled vehicle and a second controlled vehicle that travels behind the first controlled vehicle and communicates with the communication unit, and information related to a forward object that is positioned ahead of the first controlled vehicle. The control unit causes the first controlled vehicle to behave based on energy consumption of the first controlled vehicle and of the following vehicle, in response to behavior of the first controlled vehicle, acquired from the information related to the first controlled vehicle, the information related to the following vehicle, and the information related to the forward object.

### BRIEF DESCRIPTION OF THE DRAWINGS

In the accompanying drawings:

FIG. 1 is a configuration diagram illustrating a system in which a traffic flow control apparatus according to a first embodiment is used;

FIG. 2 is a flowchart illustrating a process performed by a control unit of the traffic flow control apparatus;

FIG. 3 is a diagram illustrating a relationship between deceleration of a first controlled vehicle and energy consumption of a following vehicle;

FIG. 4 is a flowchart illustrating a process performed by the first controlled vehicle in the system;

FIG. 5 is a diagram illustrating a relationship between deceleration of the first controlled vehicle, and energy consumption of the following vehicle and the first controlled vehicle;

FIG. 6 is a diagram illustrating a relationship between deceleration of the first controlled vehicle and total energy consumption;

FIG. 7 is a diagram illustrating a relationship between time and positions of the following vehicle, the first controlled vehicle, a non-controlled vehicle, and a traffic light;

FIG. 8 is a diagram illustrating a relationship between time and speeds of the following vehicle, the first controlled vehicle, the non-controlled vehicle, and the traffic light;

FIG. 9 is a flowchart illustrating a process performed by the control unit of the traffic flow control apparatus in a modification according to the first embodiment;

FIG. 10 is a flowchart of a process performed by the first controlled vehicle in the modification;

FIG. 11 is a flowchart illustrating a process performed by a control unit of a traffic flow control apparatus according to a second embodiment;

FIG. 12 is a diagram illustrating a relationship between deceleration of a first controlled vehicle and traffic volume;

FIG. 13 is a flowchart illustrating a process performed by the first controlled vehicle;

FIG. 14 is a flowchart illustrating a process performed by the control unit of the traffic flow control apparatus in a modification according to the second embodiment; and

FIG. 15 is a flowchart illustrating a process performed by the first controlled vehicle in the modification.

### DESCRIPTION OF THE EMBODIMENTS

Conventionally, as described in JP 2008-299666 A, a vehicle driving assistance system that determines a traveling state of an own vehicle based on a distance to an intersection, a speed of the own vehicle, and traffic light information of a traffic light is known. In this vehicle driving assistance system, acceleration/deceleration control is performed on the own vehicle depending on the traveling state.

In the vehicle driving assistance system described in JP 2008-299666 A, a following vehicle traveling behind the own vehicle may unnecessarily accelerate/decelerate depending on the acceleration/deceleration of the own vehicle. As a result, the own vehicle and the following vehicle waste fuel and electrical energy. Consequently, energy consumption increases in a traffic flow on a road on which the own vehicle and the following vehicle travel.

It is thus desired to provide a traffic flow control apparatus and a traffic flow control program that suppress increase in energy consumption in a traffic flow.

A first exemplary embodiment of the present disclosure provides a traffic flow control apparatus including: a communication unit; an acquiring unit that acquires information related to a first controlled vehicle that communicates with the communication unit, information related to a following vehicle that travels between the first controlled vehicle and a second controlled vehicle that travels behind the first controlled vehicle and communicates with the communication unit, and information related to a forward object that is positioned ahead of the first controlled vehicle; and a control unit that causes the first controlled vehicle to behave based on energy consumption of the first controlled vehicle and of the following vehicle, in response to behavior of the first controlled vehicle, acquired from the information related to the first controlled vehicle, the information related to the following vehicle, and the information related to the forward object.

In addition, a second exemplary embodiment of the present disclosure provides a non-transitory computer-readable storage medium storing a traffic flow control program for causing a computer to implement: acquiring information related to a first controlled vehicle that communicates with a communication unit of the traffic flow control apparatus, information related to a following vehicle that travels between the first controlled vehicle and a second controlled vehicle that travels behind the first controlled vehicle and communicates with the communication unit, and information related to a forward object that is positioned ahead of the first controlled vehicle; and causing the first controlled vehicle to behave based on energy consumption of the first controlled vehicle and of the following vehicle in relation to behavior of the first controlled vehicle, the on energy consumption being acquired from the information related to the first controlled vehicle, the information related to the following vehicle, and the information related to the forward object.

As a result, the first controlled vehicle behaves based on the energy consumption of the first controlled vehicle and of the following vehicle. Consequently, increase in energy consumption in a traffic flow on a road on which the first controlled vehicle and the following vehicle travel is suppressed.

Reference numbers in parentheses that are attached to constituent elements and the like indicate examples of corresponding relationships between the constituent elements and the like and specific constituent elements and the like described according to embodiments described hereafter.

Embodiments will hereinafter be described with reference to the drawings. Here, sections that are identical or equivalent among the embodiments described below are given the same reference numbers. Descriptions thereof are omitted.

### First Embodiment

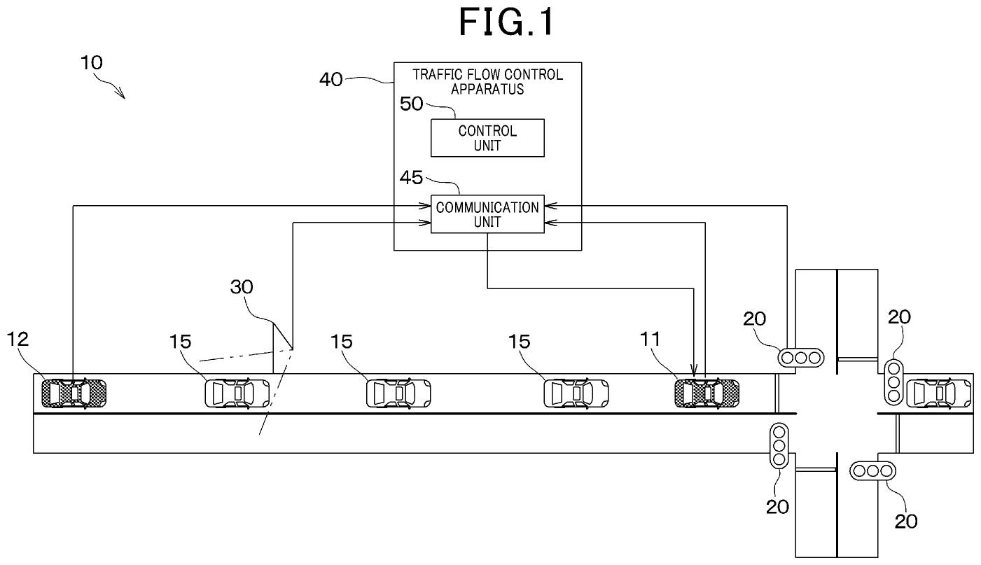

A traffic flow control apparatus according to a present embodiment suppresses increase in energy consumption in a traffic flow. For example, the traffic flow control apparatus may be used in a system 10 such as that shown in FIG. 1. First, the system 10 will be described.

The system 10 includes a first controlled vehicle 11, a second controlled vehicle 12, a following vehicle 15, a traffic light 20, an information acquisition apparatus 30, and a traffic flow control apparatus 40.

The first controlled vehicle 11 travels on a road. The first controlled vehicle 11 includes a sensor group (not shown). The sensor group detects a state of the first controlled vehicle 11 and a state of the road. The state of the first controlled vehicle 11 includes a position, speed, acceleration, and the like of the first controlled vehicle 11. The state of the road includes a gradient, curvature, and the like of the road on which the first controlled vehicle 11 travels. The sensor group also detects a number of occupants in the first controlled vehicle 11, a surrounding state of the first controlled vehicle 11, and the like. The surrounding state of the first controlled vehicle 11 includes a relative position, relative speed, and the like of an object in the vicinity of the first controlled vehicle 11. In addition, the first controlled vehicle 11 includes a microcomputer and the like, and has a central processing unit (CPU), a read-only memory (ROM), a flash memory, a random access memory (RAM), an input/output (I/O), a communication interface, a bus line connecting these components, and the like. The first controlled vehicle 11 communicates with the traffic flow control apparatus 40, described hereafter. The first controlled vehicle 11 transmits information related to the first controlled vehicle 11 to the traffic flow control apparatus 40, described hereafter. The first controlled vehicle 11 also receives information from the traffic flow control apparatus 40, described hereafter. Furthermore, the first controlled vehicle 11 performs traveling control based on the received information by implementing a program stored in the ROM of the first controlled vehicle 11

The second controlled vehicle 12 travels behind the first controlled vehicle 11. In a manner similar to the first controlled vehicle 11, the second controlled vehicle 12 communicates with the traffic flow control apparatus 40, described hereafter. The second controlled vehicle 12 transmits information related to the second controlled vehicle 12 to the traffic flow control apparatus 40, described hereafter.

The following vehicle 15 travels between the first controlled vehicle 11 and the second controlled vehicle 12. Here, in FIG. 1, the following vehicle 15 is shown in white to distinguish the following vehicle 15 from the first controlled vehicle 11 and the second controlled vehicle 12. The first controlled vehicle 11 and the second controlled vehicle 12 are shown having a dotted pattern.

The traffic light 20 is positioned ahead of the first controlled vehicle 11. The traffic light 20 transmits information related to the traffic light 20 to the traffic flow control apparatus 40, described hereafter.

The information acquisition apparatus 30 is disposed on the road on which the first controlled vehicle 11, the second controlled vehicle 12, and the following vehicle 15 travel. The information acquisition apparatus 30 acquires information related to the following vehicle 15 using a camera, image recognition, teaching data, machine learning, and the like. In addition, the information acquisition apparatus 30 transmits the acquired information to the traffic flow control apparatus 40, described hereafter. Here, while the information acquisition apparatus 30 acquires information related to the following vehicle 15 using a camera, image recognition, teaching data, machine learning, and the like, the information acquisition apparatus 30 is not limited thereto. The information acquisition apparatus 30 may acquire information related to the following vehicle 15 using radar, LiDAR, communication with the following vehicle 15, and the like. LiDAR is an abbreviation of Light Detection and Ranging/Laser Imaging Detection and Ranging.

The traffic flow control apparatus 40 is mainly configured by a microcomputer and the like, and has a CPU, a ROM, a flash memory, a RAM, an I/O, a bus line connecting these components, and the like. In addition, the traffic flow control apparatus 40 is disposed in a different location from the first controlled vehicle 11, the second controlled vehicle 12, and the following vehicle 15. The traffic flow control apparatus 40 also includes a communication unit 45 and a control unit 50.

The communication unit 45 is a communication interface or the like, and communicates with the first controlled vehicle 11, the second controlled vehicle 12, the traffic light 20, and the information acquisition apparatus 30.

The control unit 50 implements a program stored in the ROM of the traffic flow control apparatus 40. As a result, the control unit 50 generates information to cause the first controlled vehicle 11 to behave based on energy consumption of the first controlled vehicle 11 and of the following vehicle 15 in relation to the behavior of the first controlled vehicle 11, based on information related to the first controlled vehicle 11, the following vehicle 15, and the traffic light 20. For example, the control unit 50 may generate information to cause the first controlled vehicle 11 to behave so that a sum of the energy consumption of the first controlled vehicle 11 and of the following vehicle 15 in relation to the behavior of the first controlled vehicle 11 is minimized. In addition, the control unit 50 transmits the generated information to the first controlled vehicle 11. As a result, the first controlled vehicle 11 behaves based on the energy consumption of the first controlled vehicle 11 and of the following vehicle 15 in relation to the behavior of the first controlled vehicle 11. Consequently, increase in energy consumption in the traffic flow is suppressed. Here, details of the generation of information by the control unit 50 and the behavior of the first controlled vehicle 11 will be described hereafter.

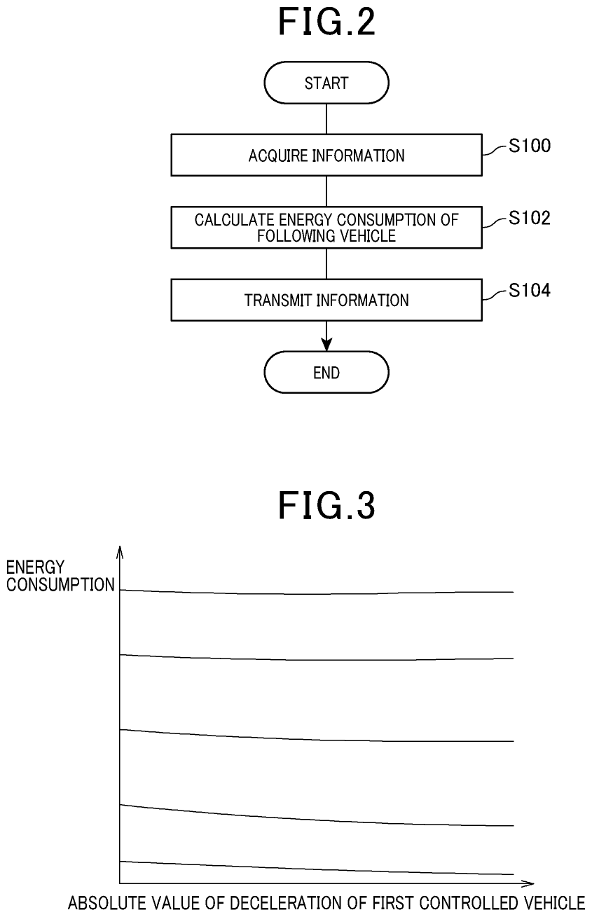

The system 10 is configured as described above. Next, the generation of information to cause the first controlled vehicle 11 to behave based on the energy consumption of the first controlled vehicle 11 and of the following vehicle 15 in relation to the behavior of the first controlled vehicle 11 performed by the control unit 50 implementing the program will be described with reference to a flowchart in FIG. 2. Here, for example, the control unit 50 may implement the program when the communication unit 45 communicates with the first controlled vehicle 11 and the second controlled vehicle 12.

At step S100, the control unit 50 acquires various types of information. Specifically, the control unit 50 acquires the information related to the first controlled vehicle 11 from the first controlled vehicle 11 through the communication unit 45. For example, the information related to the first controlled vehicle 11 may include a mass, position, speed, and type of the first controlled vehicle 11, a gradient and curvature of the road on which the first controlled vehicle 11 travels, and usage history of air conditioning, power steering, lights, and the like of the first controlled vehicle 11. Here, the type of a vehicle includes legal classification, such as a full-sized vehicle, a small-sized vehicle, a light vehicle, or a large custom-made vehicle, a type based on power, such as an engine vehicle or an electric vehicle, a type based on vehicle manufacturer, and the like.

In addition, the control unit 50 acquires the information related to the traffic light 20 from the traffic light 20 through the communication unit 45. For example, the information related to the traffic light 20 may be a lighting state of the traffic light 20 and a time at which the lighting state of the traffic light 20 changes.

Furthermore, the control unit 50 acquires the information related to the following vehicle 15 from the information acquisition apparatus 30 through the communication unit 45. For example, the information related to the following vehicle 15 may be traffic density, and a shape, size, speed, and type of the following vehicle 15. Here, the traffic density is a number of vehicles present per unit distance. A unit of traffic density may be, for example, vehicles/km.

Next, at step S102, the control unit 50 calculates the energy consumption of the following vehicle 15 in relation to the behavior of the first controlled vehicle 11.

Specifically, to calculate the energy consumption of the following vehicle 15, the control unit 50 calculates a force applied when the following vehicle 15 travels in relation to the behavior of the first controlled vehicle 11.

Here, the force applied when the vehicle travels is expressed by a sum of acceleration/deceleration resistance, a sum of rolling resistance and air resistance, a gradient resistance, and an amount of increase in rolling resistance when traveling on a curve, as expressed by relational expression (1), below. Here, in relational expression (1), below: Fdrv(t) denotes the force applied when the vehicle travels at time t; and m denotes the mass of the vehicle. The mass of the vehicle may also include the mass of the occupants of the vehicle. For example, the mass of the occupants of the first controlled vehicle 11 may be calculated by the number of occupants in the first controlled vehicle 11 detected by the sensor group of the first controlled vehicle 11 multiplied by mass per occupant set in advance. In addition, for example, the mass of the occupants in the following vehicle 15 may be calculated by the number of occupants in the following vehicle 15 detected by the information acquisition apparatus 30 multiplied by the mass per occupant set in advance. In addition: a denotes acceleration of the vehicle; m×a denotes the acceleration/deceleration resistance of the vehicle; v(t) denotes the vehicle speed at time t; and Fr(v(t)) denotes the sum of rolling resistance and air resistance at time t, and is a function of the vehicle speed. Furthermore, Fr(v(t)) is set by experiments, simulations, and the like so that the sum of rolling resistance and air resistance is calculated based on the vehicle speed. In addition: g denotes gravitational acceleration; θ(t) denotes the gradient of the road on which the vehicle travels at time t; m×g×sin(θ(t)) denotes the gradient resistance at time t; and Fc(t) denotes the amount of increase in rolling resistance when traveling on a curve at time t, and is a function of the curvature of the road. Moreover, Fc(t) is set by experiments, simulations, and the like so that the amount of increase in rolling resistance when traveling on a curve is calculated based on the curvature of the road.

$$Fdrv ( t ) = m \times a + F r ( v ( t ) ) + m \times g \times sin ( θ ( t ) ) + F c ( t ) \qquad ( 1 )$$

Therefore, for example, the control unit 50 may calculate the mass of the following vehicle 15 from the shape, size, or type of the following vehicle 15 acquired at step S100. In addition, the control unit 50 calculates the relative speed of the following vehicle 15 to the first controlled vehicle 11 from the speed of the first controlled vehicle 11 and the speed of the following vehicle 15 acquired at step S100. Furthermore, the control unit 50 calculates an average inter-vehicle distance from the traffic density acquired at step S100. Here, the average inter-vehicle distance may be, for example, a reciprocal of the traffic density.

In addition, here, the behavior of the first controlled vehicle 11 is assumed to be deceleration. The control unit 50 sets the deceleration of the first controlled vehicle 11 to calculate a relationship between the deceleration of the first controlled vehicle 11 and the energy consumption of the following vehicle 15, as described hereafter. Furthermore, the control unit 50 calculates the deceleration of the following vehicle 15 using the set deceleration, the calculated relative speed of the following vehicle 15 to the first controlled vehicle 11, the calculated average inter-vehicle distance, and a tracking model. Here, the tracking model may be, for example, a stimulus-response model.

The control unit 50 also calculates the position of the following vehicle 15 from the position of the first controlled vehicle 11 acquired at step S100 and the calculated average inter-vehicle distance. Moreover, the control unit 50 calculates the gradient and the curvature of the road on which the following vehicle 15 travels from the calculated position of the following vehicle 15 and map information stored in the traffic flow control apparatus 40 in advance.

Therefore, the control unit 50 calculates the acceleration/deceleration resistance of the following vehicle 15 from the calculated mass of the following vehicle 15 and the set deceleration of the first controlled vehicle 11. In addition, the control unit 50 calculates the sum of rolling resistance and air resistance of the following vehicle 15 from the speed of the following vehicle 15 acquired at step S100 and a function set in advance. Furthermore, the control unit 50 calculates the gradient resistance of the following vehicle 15 from the calculated mass of the following vehicle 15, the gravitational acceleration, and the calculated gradient of the road on which the following vehicle 15 travels. The control unit 50 also calculates the amount of increase in rolling resistance of the following vehicle 15 when traveling on a curve, based on the calculated curvature of the road on which the following vehicle 15 travels and a function set in advance.

Therefore, the control unit 50 calculates the sum of the calculated acceleration/deceleration resistance, the sum of rolling resistance and air resistance, the gradient resistance, and the amount of increase in the rolling resistance when traveling on a curve. The control unit 50 thereby calculates the force applied when the following vehicle 15 travels. Furthermore, the control unit 50 changes the set deceleration of the first controlled vehicle 11 and calculates the force applied when the following vehicle 15 travels for each deceleration of the first controlled vehicle 11. As a result, the control unit 50 calculates the force applied when the following vehicle 15 travels in relation to the behavior of the first controlled vehicle 11.

Next, the control unit 50 calculates power to be outputted by the following vehicle 15 in relation to the behavior of the first controlled vehicle 11 from the calculated force applied when the following vehicle 15 travels in relation to the behavior of the first controlled vehicle 11.

Here, the power to be outputted by the vehicle is expressed by a sum of a value obtained by the force applied when the vehicle travels being multiplied by the vehicle speed, and power required for purposes other than vehicle travel, as shown in relational expression (2), below. Here, in relational expression (2), below: Pdrv(t) denotes the power to be outputted by the vehicle at time t; Fdrv(t) denotes the force applied when the vehicle travels at time t, as described above; v(t) denotes the vehicle speed at time t, as described above; and Paux denotes the power required for purposes other than vehicle travel and is the power consumed by the air conditioning, power steering, lights, and the like of the vehicle.

$$Pdrv ( t ) = Fdrv ( t ) \times v ( t ) + Paux \qquad ( 2 )$$

In addition, the power required for purposes other than vehicle travel varies depending on the traveling state of the vehicle and the type of the vehicle. Furthermore, the following vehicle 15 travels on the same road as the first controlled vehicle 11. Therefore, the control unit 50 calculates the power required for purposes other than traveling of the following vehicle 15 from the usage history of air conditioning, power steering, lights, and the like of the first controlled vehicle 11 acquired at step S100, the type of the following vehicle 15 acquired at step S100, and a map. Here, the map for calculating the power required for purposes other than traveling of the following vehicle 15 is set by experiments, simulations, and the like.

Then, the control unit 50 calculates the power to be outputted by the following vehicle 15 from the calculated power required for purposes other than traveling of the following vehicle 15, the calculated force applied when the following vehicle 15 travels, and the speed of the following vehicle 15 acquired at step S100. The control unit 50 also calculates the power to be outputted by the following vehicle 15 for each deceleration of the first controlled vehicle 11. The control unit 50 thereby calculates the power to be outputted by the following vehicle 15 in relation to the behavior of the first controlled vehicle 11.

Next, the control unit 50 calculates power consumption of the following vehicle 15 in relation to the behavior of the first controlled vehicle 11 from the calculated power to be outputted by the following vehicle 15 in relation to the behavior of the first controlled vehicle 11.

Here, for example, when the vehicle may be an engine vehicle in which a CVT or the like is mounted, the power consumption of the vehicle is expressed by a value obtained by the power to be outputted by the vehicle being divided by a value obtained by engine efficiency being multiplied by CVT transmission efficiency, as shown in relational expression (3), below. Here, CVT is an abbreviation of Continuously Variable Transmission. In addition, in relational expression (3), below: Pfuel(t) denotes fuel power consumption of the vehicle at time t, and corresponds to the power consumption of the vehicle; Pdrv(t) denotes the power to be outputted by the vehicle at time t, as described above; ηeng(Peng) denotes the engine efficiency of the vehicle; and ηmec(Peng) denotes the CVT transmission efficiency of the vehicle. Furthermore, ηeng(Peng) and ηmec are set in advance through experiments, simulations, and the like so that Pfuel(t) is calculated.

$$Pfuel ( t ) = \frac{P d r v ( t )}{η en g ( P e n g ) \times η m e c ( P e n g )} \qquad ( 3 )$$

Therefore, when the type of the following vehicle 15 acquired at step S100 is an engine vehicle, the control unit 50 calculates the power consumption of the following vehicle 15 from the calculated power to be outputted by the following vehicle 15, and the engine efficiency and CVT transmission efficiency set in advance. In addition, the control unit 50 calculates the power consumption of the following vehicle 15 for each deceleration of the first controlled vehicle 11. The control unit 50 thereby calculates the power consumption of the following vehicle 15 in relation to the behavior of the first controlled vehicle 11.

Furthermore, here, for example, when the vehicle may be an electric vehicle, the power consumption of the vehicle may be expressed by a sum of battery output power of the vehicle and battery loss of the vehicle, as shown in relational expression (4-1), below. Here, in relational expression (4-1), below: Pelc(t) denotes electrical power consumption of the vehicle at time t and corresponds to the power consumption of the vehicle; Pbat(Pdrv(t)) denotes the battery output power of the vehicle at time t; Pdrv(t) denotes the power to be outputted by the vehicle at time t, as described above; and Pbtl{Pbat(Pdrv(t))} denotes the battery loss of the vehicle at time t.

In addition, the battery output power of the vehicle is expressed using the power to be outputted by the vehicle, motor efficiency of the vehicle, and transmission efficiency of a gear in the vehicle, as shown in relational expression (4-2), below. Here, in relational expression (4-2), below: ηmot denotes the motor efficiency of the vehicle; and ηmec(Pelc) denotes the transmission efficiency of the gear in the vehicle. Furthermore, ηmot and ηmec (Pelc) are set in advance through experiments, simulations, and the like so that Pbat(Pdrv(t)) is calculated.

In addition, the battery loss of the vehicle is expressed using internal resistance of a battery in the vehicle, the battery output power of the vehicle, and a voltage of the battery in the vehicle, as shown in relational expression (4-3), below. Here, in relational expression (4-3), below: Rbat denotes the internal resistance of the battery in the vehicle; and Vbat denotes the voltage of the battery in the vehicle. Rbat and Vbat are set in advance based on vehicle and battery specifications and the like.

$$Pelc ( t ) = Pbat ( P d r v ( t ) ) + Pbtl \{ P b a t ( P d r v ( t ) ) \} \qquad ( 4 - 1 )$$

$$Pbat ( Pdrv ( t ) ) = \{ \begin{matrix}\frac{Pdrv ( t )}{η mot \times η mec ( Pelc )} & ( Pdrv ( t ) \geq 0 ) \\ η mot \times η mec ( Pelc ) \times Pdrv ( t ) & ( Pdrv ( t ) < 0 )\end{matrix} \qquad ( 4 - 2 )$$

$$Pbtl \{ Pbat ( Pdrv ( t ) ) \} = Rbat \times {( \frac{Pbat ( Pdrv ( t ) )}{Vbat} )}^{2} \qquad ( 4 - 3 )$$

Therefore, when the type of the following vehicle 15 acquired at step S100 is an electric vehicle, the control unit 50 calculates the battery output power of the following vehicle 15 from the calculated power to be outputted by the following vehicle 15, and the motor efficiency and the transmission efficiency of the gear set in advance. In addition, the control unit 50 calculates the battery loss of the following vehicle 15 from the calculated battery output power of the following vehicle 15 and the internal resistance and voltage of the battery of the following vehicle 15 set in advance.

Therefore, the control unit 50 calculates the sum of the calculated battery output power and battery loss of the following vehicle 15. The control unit 50 thereby calculates the power consumption of the following vehicle 15. Furthermore, the control unit 50 calculates the power consumption of the following vehicle 15 for each deceleration of the first controlled vehicle 11. The control unit 50 thereby calculates the power consumption of the following vehicle 15 in relation to the behavior of the first controlled vehicle 11.

Then, the control unit 50 calculates the energy consumption of the following vehicle 15 in relation to the behavior of the first controlled vehicle 11 from the calculated power consumption of the following vehicle 15 in relation to the behavior of the first controlled vehicle 11.

Here, the light of the traffic light 20 is assumed to be red. At this time, when the vehicle stops in front of the traffic light 20, the energy consumption of the vehicle increases due to strong deceleration. Therefore, increase in energy consumption of the vehicle is suppressed by the vehicle not stopping in front of the traffic light 20 and passing through the traffic light 20 after the light of the traffic light 20 turns green. Thus, increase in energy consumption of the vehicle is suppressed by the vehicle decelerating when the light of the traffic light 20 is red and accelerating when the light of the traffic light 20 changes from red to green. Therefore, increase in energy consumption of the vehicle is further suppressed as energy consumption when the vehicle decelerates until the lighting state of the traffic light 20 changes decreases.

Therefore, the control unit 50 multiplies the calculated power consumption of the following vehicle 15 in relation to the behavior of the first controlled vehicle 11 by time at which the lighting state of the traffic light 20 changes calculated at step S100. The control unit 50 thereby calculates the energy consumption of the following vehicle 15 in relation to the behavior of the first controlled vehicle 11, such as that shown in FIG. 3. As a result, the control unit 50 generates information to cause the first controlled vehicle 11 to behave based on the energy consumption of the first controlled vehicle 11 and of the following vehicle 15 in relation to the behavior of the first controlled vehicle 11. Subsequently, the process performed by the control unit 50 proceeds to step S104. Here, FIG. 3 may show for example, respective energy consumption of five following vehicles 15 relative to an absolute value of the deceleration of the first controlled vehicle 11.

Next, at step S104, the control unit 50 transmits the information related to the following vehicle 15 and the information related to the traffic light 20 acquired at step S100 to the first controlled vehicle 11 through the communication unit 45. In addition, the control unit 50 transmits the energy consumption of the following vehicle 15 in relation to the behavior of the first controlled vehicle 11 calculated at step S102 to the first controlled vehicle 11 through the communication unit 45. As a result, as described hereafter, the first controlled vehicle 11 behaves based on the energy consumption of the first controlled vehicle 11 and of the following vehicle 15 in relation to the behavior of the first controlled vehicle 11. Subsequently, the process performed by the control unit 50 is ended.

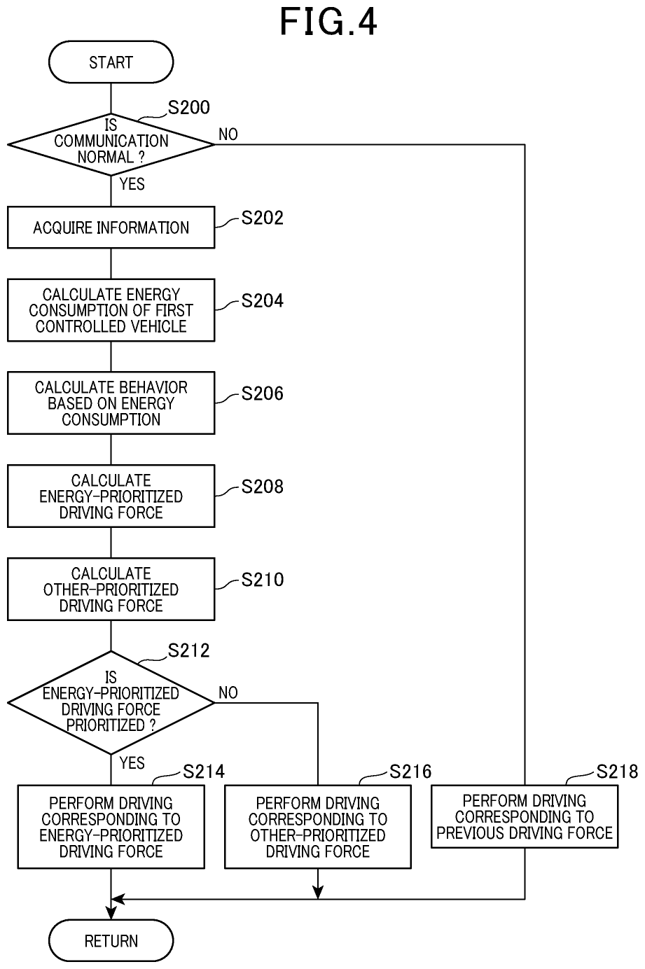

As described above, the control unit 50 generates the information to cause the first controlled vehicle 11 to behave based on the energy consumption of the first controlled vehicle 11 and of the following vehicle 15 in relation to the behavior of the first controlled vehicle 11, based on the information related to the first controlled vehicle 11, the following vehicle 15, and the traffic light 20. Next, the behavior of the first controlled vehicle 11 as a result of the first controlled vehicle 11 implementing a program will be described with reference to a flowchart in FIG. 4. Here, the program of the first controlled vehicle 11 may be implemented, for example, when ignition or power of the first controlled vehicle 11 may be turned on.

At step S200, for example, the first controlled vehicle 11 determines whether a signal from the control unit 50 can be received. The first controlled vehicle 11 thereby determines whether communication with the communication unit 45 is normal. When the communication between the first controlled vehicle 11 and the communication unit 45 is not normal, that is, when an abnormality has occurred, the process performed by the first controlled vehicle 11 proceeds to step S218. In addition, when the communication with the communication unit 45 is normal, the process performed by the first controlled vehicle 11 proceeds to step S202.

At step S202 following step S200, the first controlled vehicle 11 acquires, from the control unit 50, the information related to the following vehicle 15, the information related to the traffic light 20, and the energy consumption of the following vehicle 15 in relation to the behavior of the first controlled vehicle 11. In addition, the first controlled vehicle 11 acquires information related to the first controlled vehicle 11 and a surrounding state thereof from the sensor group of the first controlled vehicle 11.

Next, at step S204, the first controlled vehicle 11 calculates the energy consumption of the first controlled vehicle 11 in relation to the behavior of the first controlled vehicle 11, in a manner similar to the calculation of the energy consumption of the following vehicle 15 in relation to the behavior of the first controlled vehicle 11 described above.

Specifically, the first controlled vehicle 11 calculates the acceleration/deceleration resistance in the first controlled vehicle 11 from the mass of the first controlled vehicle 11 and the deceleration of the first controlled vehicle 11 that serves as a variable. In addition, the first controlled vehicle 11 calculates the sum of rolling resistance and air resistance of the first controlled vehicle 11 from the speed of the first controlled vehicle 11 and a function set in advance. The first controlled vehicle 11 also calculates the gradient resistance of the first controlled vehicle 11 from the mass of the first controlled vehicle 11, the gravitational acceleration, and the gradient of the road on which the first controlled vehicle 11 travels. Furthermore, the first controlled vehicle 11 calculates the amount of increase in rolling resistance of the first controlled vehicle 11 when traveling on a curve from the curvature of the road on which the first controlled vehicle 11 travels and a function set in advance.

Therefore, the first controlled vehicle 11 calculates the sum of the calculated acceleration/deceleration resistance, the sum of rolling resistance and air resistance, the gradient resistance, and the amount of increase in the rolling resistance when traveling on a curve. The first controlled vehicle 11 thereby calculates the force applied when the first controlled vehicle 11 travels. The first controlled vehicle 11 also changes the deceleration of the first controlled vehicle 11 and calculates the force applied when the first controlled vehicle 11 travels for each deceleration of the first controlled vehicle 11. The first controlled vehicle 11 thereby calculates the force applied when the first controlled vehicle 11 travels in relation to the behavior of the first controlled vehicle 11.

Next, the first controlled vehicle 11 calculates the power required for purposes other than traveling of the first controlled vehicle 11 from the usage history of the air conditioning, power steering, lights, and the like of the first controlled vehicle 11. In addition, the first controlled vehicle 11 calculates the power to be outputted by the first controlled vehicle 11 from the calculated power required for purposes other than traveling of the first controlled vehicle 11, the calculated force applied when the first controlled vehicle 11 travels, and the speed of the first controlled vehicle 11. The first controlled vehicle 11 also calculates the power to be outputted by the first controlled vehicle 11 for each deceleration of the first controlled vehicle 11. The first controlled vehicle 11 thereby calculates the power to be outputted by the first controlled vehicle 11 in relation to the behavior of the first controlled vehicle 11.

Next, when the type of the first controlled vehicle 11 is an engine vehicle, the first controlled vehicle 11 calculates the power consumption of the first controlled vehicle 11 from the calculated power to be outputted by the first controlled vehicle 11, and the engine efficiency and CVT transmission efficiency set in advance. In addition, the first controlled vehicle 11 calculates the power consumption of the first controlled vehicle 11 for each deceleration of the first controlled vehicle 11. The first controlled vehicle 11 thereby calculates the power consumption of the first controlled vehicle 11 in relation to the behavior of the first controlled vehicle 11.

Furthermore, when the type of the first controlled vehicle 11 is an electric vehicle, the first controlled vehicle 11 calculates the battery output power of the first controlled vehicle 11 from the calculated power to be outputted from the first controlled vehicle 11, and the motor efficiency and the transmission efficiency of the gear set in advance. In addition, the first controlled vehicle 11 calculates the battery loss of the first controlled vehicle 11 from the calculated battery output power of the first controlled vehicle 11, and the internal resistance and voltage of the first controlled vehicle 11 set in advance. The first controlled vehicle 11 also calculates the sum of the calculated battery output power and battery loss of the first controlled vehicle 11. The first controlled vehicle 11 thereby calculates the power consumption of the first controlled vehicle 11. The first controlled vehicle 11 also calculates the power consumption of the first controlled vehicle 11 for each deceleration of the first controlled vehicle 11. The first controlled vehicle 11 thereby calculates the power consumption of the first controlled vehicle 11 in relation to the behavior of the first controlled vehicle 11.

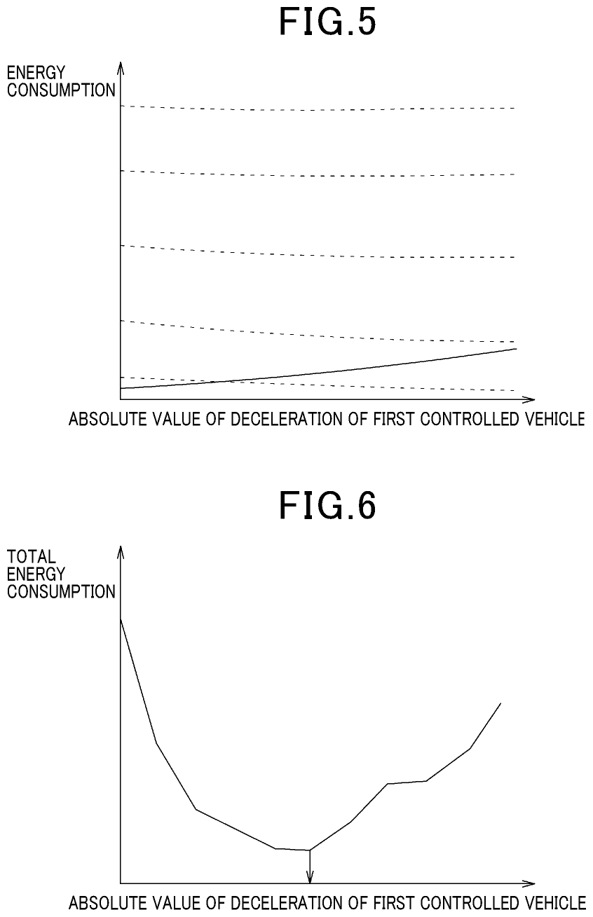

Then, the first controlled vehicle 11 multiplies the calculated power consumption of the first controlled vehicle 11 in relation to the behavior of the first controlled vehicle 11 by the time at which the lighting state of the traffic light 20 changes acquired at step S202. The first controlled vehicle 11 thereby calculates the energy consumption of the first controlled vehicle 11 in relation to the behavior of the first controlled vehicle 11, such as that shown in FIG. 5. Here, FIG. 5 shows the energy consumption of the first controlled vehicle 11 in addition to the respective energy consumption of the five following vehicles 15 relative to the absolute value of the deceleration of the first controlled vehicle 11. In addition, in FIG. 5, in order to distinguish the energy consumption of the first controlled vehicle 11 from the energy consumption of the following vehicle 15, the energy consumption of each of the five following vehicles 15 is shown by a broken line. Furthermore, the energy consumption of the first controlled vehicle 11 is shown by a solid line.

Returning to FIG. 4, next, at step S206, the first controlled vehicle 11 calculates behavior based on the energy consumption of the first controlled vehicle 11 and of the following vehicle 15 in relation to the behavior of the first controlled vehicle 11. For example, here, the first controlled vehicle 11 may calculate behavior by which the sum of the energy consumption of the following vehicle 15 and of the first controlled vehicle 11 in relation to the behavior of the first controlled vehicle 11 is minimized.

Specifically, the first controlled vehicle 11 adds the energy consumption of the following vehicle 15 acquired at step S202 and the energy consumption of the first controlled vehicle 11 calculated at step S204. The first controlled vehicle 11 thereby calculates total energy consumption relative to the absolute value of the deceleration of the first controlled vehicle 11, as shown in FIG. 6. The first controlled vehicle 11 also calculates the deceleration of the first controlled vehicle 11 at which the calculated total energy consumption is minimized. The first controlled vehicle 11 thereby calculates the behavior by which the sum of the energy consumption of the following vehicle 15 and the first controlled vehicle 11 is minimized.

Returning to FIG. 4, next, at step S208, the first controlled vehicle 11 calculates driving force corresponding to behavior based on the energy consumption of the first controlled vehicle 11 and of the following vehicle 15 in relation to the behavior of the first controlled vehicle 11 calculated at step S206. Hereafter, the driving force corresponding to behavior based on the energy consumption of the first controlled vehicle 11 and of the following vehicle 15 in relation to the behavior of the first controlled vehicle 11 will be referred to as energy-prioritized driving force.

For example, the first controlled vehicle 11 may calculate the energy-prioritized driving force using the deceleration of the first controlled vehicle 11 at which the total energy consumption calculated at step S206 is minimized and a map. Here, the map for calculating the energy-prioritized driving force is set through experiments, simulations, and the like.

Next, at step S210, the first controlled vehicle 11 calculates driving force corresponding to content differing from the energy consumption of the following vehicle 15 and the first controlled vehicle 11, from the information acquired at step S202. Here, the driving force corresponding to content differing from the energy consumption of the following vehicle 15 and the first controlled vehicle 11 will be referred to as other-prioritized driving force.

For example, the content differing from the energy consumption of the following vehicle 15 and the first controlled vehicle 11 may be traffic volume. Here, traffic volume is a number of vehicles passing through a certain point per unit time. A unit of traffic volume may be, for example, vehicles/h.

In this case, for example, the first controlled vehicle 11 may correct the speed of the following vehicle 15 and the speed of the first controlled vehicle 11 based on the speed of the following vehicle 15, the lighting state of the traffic light 20, the time at which the lighting state changes, and the speed of the first controlled vehicle 11 acquired at step S202. For example, when the light of the traffic light 20 may be red, the speeds of the following vehicle 15 and the first controlled vehicle 11 may tend to decrease. Therefore, at this time, the first controlled vehicle 11 reduces the speed of the following vehicle 15 and the speed of the first controlled vehicle 11 as the time at which the lighting state of the traffic light 20 changes becomes longer. In addition, when the light of the traffic light 20 is green, the speeds of the following vehicle 15 and the first controlled vehicle 11 tend to increase. Therefore, at this time, the first controlled vehicle 11 increases the speed of the following vehicle 15 and the speed of the first controlled vehicle 11 as the time at which the lighting state of the traffic light 20 changes becomes longer.

Furthermore, the first controlled vehicle 11 calculates a harmonic mean of the corrected speeds of the following vehicle 15 and the first controlled vehicle 11. Here, the harmonic mean is a reciprocal of an arithmetic mean of a reciprocal of each number.

The first controlled vehicle 11 then multiplies the calculated harmonic-mean speed by the traffic density acquired at step S202. The first controlled vehicle 11 thereby calculates the traffic volume. In addition, the first controlled vehicle 11 changes the deceleration of the first controlled vehicle 11 and calculates the traffic volume for each deceleration of the first controlled vehicle 11. The first controlled vehicle 11 thereby calculates the traffic volume relative to the deceleration of the first controlled vehicle 11.

Furthermore, the first controlled vehicle 11 calculates the deceleration of the first controlled vehicle 11 at which the traffic volume is maximized from the calculated traffic volume relative to the deceleration of the first controlled vehicle 11. The first controlled vehicle 11 also calculates the other-prioritized driving force from the calculated deceleration and a map. Here, the map for calculating the other-prioritized driving force is set through experiments, simulations, and the like.

In addition, for example, the content differing from the energy consumption of the following vehicle 15 and the first controlled vehicle 11 may be drivability of the first controlled vehicle 11. In this case, for example, the first controlled vehicle 11 may calculate a value related to the drivability of the first controlled vehicle 11 from the deceleration of the first controlled vehicle 11 and a map. Furthermore, the first controlled vehicle 11 changes the deceleration of the first controlled vehicle 11 and calculates the value related to the drivability of the first controlled vehicle 11 for each deceleration of the first controlled vehicle 11. The first controlled vehicle 11 thereby calculates the value related to the drivability of the first controlled vehicle 11 relative to the deceleration of the first controlled vehicle 11. Here, the map for the value related to drivability is set through experiments, simulations, and the like.

In addition, the first controlled vehicle 11 calculates deceleration of the first controlled vehicle 11 at which the value related to the drivability of the first controlled vehicle 11 is maximized from the calculated value related to the drivability of the first controlled vehicle 11 relative to the deceleration of the first controlled vehicle 11. The first controlled vehicle 11 also calculates the other-prioritized driving force from the calculated deceleration and a map.

Furthermore, for example, the content differing from the energy consumption of the following vehicle 15 and the first controlled vehicle 11 may be safety of the first controlled vehicle 11 and its surroundings. In this case, for example, the first controlled vehicle 11 may calculate a value related to safety based on a distance from the first controlled vehicle 11 to a surrounding object and a relative speed of the surrounding object to the first controlled vehicle 11 acquired from the sensor group of the first controlled vehicle 11, and a map. In addition, the first controlled vehicle 11 changes the deceleration of the first controlled vehicle 11 and calculates the value related to safety for each deceleration of the first controlled vehicle 11. The first controlled vehicle 11 thereby calculates the value related to safety relative to the deceleration of the first controlled vehicle 11.

The first controlled vehicle 11 also calculates the deceleration of the first controlled vehicle 11 at which the value related to safety is maximized from the calculated value related to safety relative to the deceleration of the first controlled vehicle 11. The first controlled vehicle 11 also calculates the other-prioritized driving force from the calculated deceleration and a map.

Next, at step S212, the first controlled vehicle 11 selects which of the energy-prioritized driving force calculated at step S208 and the other-prioritized driving force calculated at step S210 to prioritize.

Here, a relatively smaller driving force of the first controlled vehicle 11 has a relatively smaller effect on the first controlled vehicle 11 and its surroundings. For this reason, for example, the first controlled vehicle 11 may compare the energy-prioritized driving force and the other-prioritized driving force. The first controlled vehicle 11 thereby selects which of the energy-prioritized driving force and the other-prioritized driving force to prioritize. Then, the first controlled vehicle 11 prioritizes the energy-prioritized driving force when the energy-prioritizing driving force is equal to or less than the other-prioritized driving force. Subsequently, the process performed by the first controlled vehicle 11 proceeds to step S214. In addition, when the energy-prioritized driving force is greater than the other-prioritized driving force, the first controlled vehicle 11 prioritizes the other-prioritized driving force. Subsequently, the process performed by the first controlled vehicle 11 proceeds to step S216.

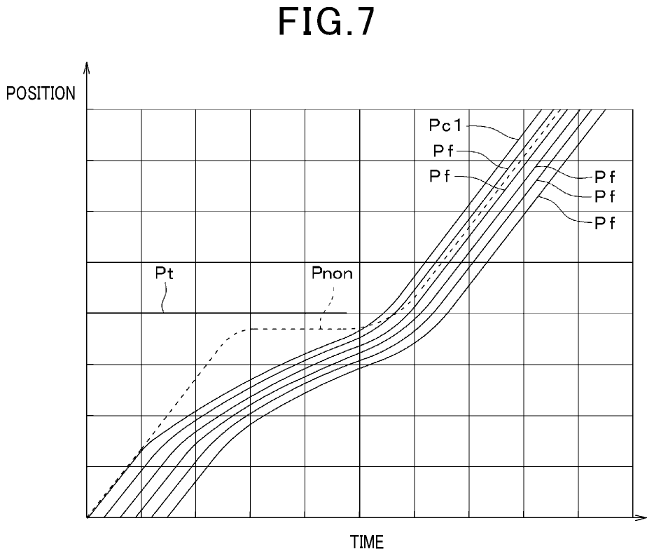

At step S214 following step S212, the first controlled vehicle 11 performs driving corresponding to the energy-prioritized driving force calculated at step S208. As a result, the first controlled vehicle 11 behaves based on the energy consumption of the first controlled vehicle 11 and of the following vehicle 15 in relation to the behavior of the first controlled vehicle 11. Here, the first controlled vehicle 11 behaves so that the sum of the energy consumption of the first controlled vehicle 11 and of the following vehicle 15 in relation to the behavior of the first controlled vehicle 11 is minimized. For example, when the behavior of the first controlled vehicle 11 may be deceleration, as shown in FIG. 7, a non-controlled vehicle that is a vehicle that is not processed by the control unit 50 and the first controlled vehicle 11 may stop in front of the traffic light 20. In contrast, the first controlled vehicle 11 and the following vehicle 15 pass through the traffic light 20 without stopping in front of the traffic light 20. At this time, the sum of the energy consumption of the first controlled vehicle 11 and of the following vehicle 15 is minimized. Subsequently, the process performed by the first controlled vehicle 11 returns to step S200. Here, FIG. 7 shows the positions of the first controlled vehicle 11, the following vehicle 15, and the traffic light 20 relative to time. In addition, in FIG. 7, a position of the non-controlled vehicle that is a vehicle that is not processed by the control unit 50 and the first controlled vehicle 11 is indicated by Pnon and a broken line. Furthermore, a position of the first controlled vehicle 11 is indicated by Pc1 and a solid line. A position of the following vehicle 15 is indicated by Pf and a solid line. A position of the traffic light 20 when the light is red is indicated by Pt and a solid line. Moreover, when the behavior of the first controlled vehicle 11 is deceleration, the first controlled vehicle 11 and the following vehicle 15 may perform deceleration regeneration or coasting. Coasting refers to coasting in a state in which an accelerator of the vehicle is turned off.

Returning to FIG. 4, at step S216 following step S212, the first controlled vehicle 11 performs driving corresponding to the other-prioritized driving force calculated at step S210. As a result, the behavior of the first controlled vehicle 11 is changed to the behavior corresponding to content differing from the energy consumption of the following vehicle 15 and the first controlled vehicle 11.

For example, when the content differing from the energy consumption of the following vehicle 15 and the first controlled vehicle 11 may be traffic volume, the first controlled vehicle 11 behaves so that the traffic volume is maximized. In addition, for example, when the content differing from the energy consumption of the following vehicle 15 and the first controlled vehicle 11 may be the drivability of the first controlled vehicle 11, the first controlled vehicle 11 may behave so that the value related to the drivability of the first controlled vehicle 11 is maximized. Furthermore, for example, when the content differing from the energy consumption of the following vehicle 15 and the first controlled vehicle 11 may be the safety of the first controlled vehicle 11 and its surroundings, the first controlled vehicle 11 may behave so that the value related to safety is maximized. Subsequently, the process performed by the first controlled vehicle 11 returns to step S200.

At step S218 following step S200, an abnormality has occurred in the communication between the first controlled vehicle 11 and the communication unit 45. At this time, the first controlled vehicle 11 cannot acquire the information related to the following vehicle 15 and the information related to the traffic light 20 from the control unit 50. Therefore, at this time, the first controlled vehicle 11 behaves as before the occurrence of the abnormality in the communication with the communication unit. For example, the first controlled vehicle 11 may behave based on the energy consumption of the first controlled vehicle 11 and of the following vehicle 15 in relation to the behavior of the first controlled vehicle 11 calculated before the occurrence of the abnormality in the communication with the communication unit 45. As a result, even if an abnormality occurs in the communication with the communication unit 45, the first controlled vehicle 11 can continue to behave based on the energy consumption of the first controlled vehicle 11 and of the following vehicle 15 in relation to the behavior of the first controlled vehicle 11. Subsequently, the process performed by the first controlled vehicle 11 returns to step S200. Here, when an abnormality has occurred in the communication with the communication unit 45, the first controlled vehicle 11 may behave so that the traffic volume, the value related to drivability, or the value related to safety of the first controlled vehicle 11 before the occurrence of the abnormality in the communication with the communication unit 45 is maximized.

The first controlled vehicle 11 performs the process as described above. Next, suppression of increase in energy consumption in a traffic flow by the traffic flow control apparatus 40 will be described.

In the traffic flow control apparatus 40 according to the first embodiment, the control unit 50 serves as an acquiring unit that acquires the information related to the first controlled vehicle 11, the information related to the following vehicle 15, and the information related to the traffic light 20. In addition, the control unit 50 causes the first controlled vehicle 11 to behave based on the energy consumption of the first controlled vehicle 11 and of the following vehicle 15 in relation to the behavior of the first controlled vehicle 11 obtained from the acquired information. For example, the control unit 50 may cause the first controlled vehicle 11 to behave so that the sum of the energy consumption of the first controlled vehicle 11 and of the following vehicle 15 in relation to the behavior of the first controlled vehicle 11 is minimized. Furthermore, for example, here, at step S102 by the control unit 50, the energy consumption of the following vehicle 15 in relation to the behavior of the first controlled vehicle 11 may be calculated. Also, at step S204 by the first controlled vehicle 11, the energy consumption of the first controlled vehicle 11 in relation to the behavior of the first controlled vehicle 11 is calculated. Then, at step S214, the first controlled vehicle 11 behaves based on the energy consumption of the first controlled vehicle 11 and of the following vehicle 15 in relation to the behavior of the first controlled vehicle 11. In addition, the behavior based on the energy consumption of the first controlled vehicle 11 and of the following vehicle 15 in relation to the behavior of the first controlled vehicle 11 may be, for example, deceleration. Moreover, the information related to the following vehicle 15 may include the type of the following vehicle 15. Here, the traffic light 20 corresponds to a forward object.

As a result, because the first controlled vehicle 11 behaves based on the energy consumption of the first controlled vehicle 11 and of the following vehicle 15, increase in the energy consumption in the traffic flow on the road on which the first controlled vehicle 11 and the following vehicle 15 travel is suppressed.

Furthermore, the traffic flow control apparatus 40 according the first embodiment also achieves the following effects.

[1-1] The traffic flow control apparatus 40 is disposed in a different location from the first controlled vehicle 11, the second controlled vehicle 12, and the following vehicle 15.

As a result, the first controlled vehicle 11 no longer needs to calculate the energy consumption of the following vehicle 15 in relation to the behavior of the first controlled vehicle 11. Consequently, calculation processing load on the first controlled vehicle 11 is suppressed.

[1-2] At step S210, step S212, and step S216, the first controlled vehicle 11 changes the behavior of the first controlled vehicle 11 to behavior corresponding to content differing from the energy consumption of the following vehicle 15 and the first controlled vehicle 11.

For example, the first controlled vehicle 11 may change the behavior of the first controlled vehicle 11 based on traffic volume in relation to the behavior of the first controlled vehicle 11. For example, the first controlled vehicle 11 may set the behavior of the first controlled vehicle 11 to behavior in which the traffic volume in relation to the behavior of the first controlled vehicle 11 is maximized. Consequently, the first controlled vehicle 11 can travel in heavy traffic.

In addition, for example, the first controlled vehicle 11 may change the behavior of the first controlled vehicle 11 based on a value related to the drivability of the first controlled vehicle 11. For example, the first controlled vehicle 11 may set the behavior of the first controlled vehicle 11 to behavior in which the value related to the drivability of the first controlled vehicle 11 is maximized. Consequently, the first controlled vehicle 11 can travel with high drivability.

Furthermore, for example, the first controlled vehicle 11 may change the behavior of the first controlled vehicle 11 based on a value related to safety of the first controlled vehicle 11. For example, the first controlled vehicle 11 may set the behavior of the first controlled vehicle 11 to behavior in which the value related to safety of the first controlled vehicle 11 is maximized. Consequently, the first controlled vehicle 11 can travel with high safety.

[1-3] At step S200 and step S218, when an abnormality has occurred in the communication with the communication unit 45, the first controlled vehicle 11 behaves based on the energy consumption of the first controlled vehicle 11 and of the following vehicle 15 before the occurrence of the abnormality in the communication with the communication unit 45.

Consequently, even if an abnormality occurs in the communication with the communication unit 45, the first controlled vehicle 11 can continue to behave based on the energy consumption of the first controlled vehicle 11 and of the following vehicle 15.

### Modification 1 According to the First Embodiment

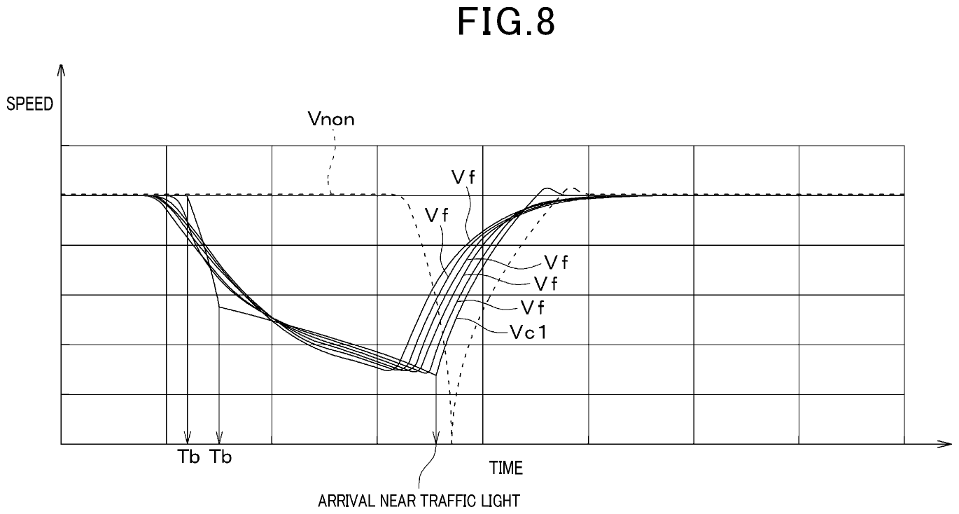

According to the above-described first embodiment, the energy consumption of the first controlled vehicle 11 and of the following vehicle 15 relative to the deceleration of the first controlled vehicle 11 is calculated as the energy consumption of the first controlled vehicle 11 and of the following vehicle 15 in relation to the behavior of the first controlled vehicle 11. In contrast, as the energy consumption of the first controlled vehicle 11 and of the following vehicle 15 in relation to the behavior of the first controlled vehicle 11, the energy consumption of the first controlled vehicle 11 and of the following vehicle 15 relative to a deceleration timing of the first controlled vehicle 11, such as that shown in FIG. 8, may be calculated. Even in such a case, effects similar to those according to the first embodiment can be achieved. Here, in FIG. 8, the speeds of the first controlled vehicle 11 and the following vehicle 15, and a speed of a non-controlled vehicle that is a vehicle that is not processed by the control unit 50 and the first controlled vehicle 11 are shown relative to time. In FIG. 8, the speed of the first controlled vehicle 11 is indicated by Vc1 and a solid line. The speed of the following vehicle 15 is indicated by Vf and a solid line. The speed of the non-controlled vehicle that is a vehicle that is not processed by the control unit 50 and the first controlled vehicle 11 is indicated by Vnon and a broken line. Furthermore, the deceleration timing of the first controlled vehicle 11 is indicated by Tb.

### Modification 2 According to the First Embodiment

According to the above-described first embodiment, at steps S204 to S210, the first controlled vehicle 11 calculates the energy consumption of the first controlled vehicle 11, the behavior based on the energy consumption, the energy-prioritized driving force, and the other-prioritized driving force. In contrast, instead of the first controlled vehicle 11, the control unit 50 may calculate the energy consumption of the first controlled vehicle 11, the behavior based on the energy consumption, the energy-prioritized driving force, and the other-prioritized driving force.

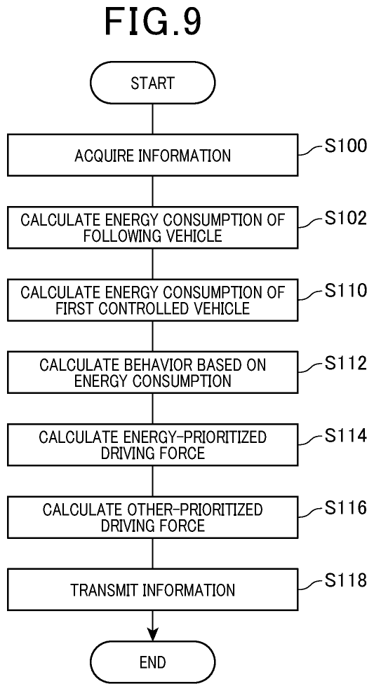

Specifically, as shown in a flowchart in FIG. 9, at S100, the control unit 50 acquires the information related to the first controlled vehicle 11, the information related to the following vehicle 15, and the information related to the traffic light 20. At step S102 following step S100, the control unit 50 calculates the energy consumption of the following vehicle 15 in relation to the behavior of the first controlled vehicle 11, in a manner similar to that described above.

At step S110 following step S102, the control unit 50 calculates the energy consumption of the first controlled vehicle 11 in relation to the behavior of the first controlled vehicle 11, in a manner similar to the process performed by the first controlled vehicle 11 at step S204.

Next, at step S112, the control unit 50 calculates the behavior based on the energy consumption of the first controlled vehicle 11 and of the following vehicle 15 in relation to the behavior of the first controlled vehicle 11, in a manner similar to the process performed by the first controlled vehicle 11 at step S206. For example, the control unit 50 may calculate behavior by which the sum of the energy consumption of the following vehicle 15 and the first controlled vehicle 11 in relation to the behavior of the first controlled vehicle 11 is minimized.

Next, at step S114, the control unit 50 calculates the energy-prioritized driving force in a manner similar to the process performed by the first controlled vehicle 11 at step S208. Next, at step S116, the control unit 50 calculates the other-prioritized driving force in a manner similar to the process performed by the first controlled vehicle 11 at step S210.

Next, at step S118, the control unit 50 transmits information related to the energy-prioritized driving force calculated at step S114 and the other-prioritized driving force calculated at step S116 to the first controlled vehicle 11 through the communication unit 45. As a result, the control unit 50 causes the first controlled vehicle 11 to behave based on the energy consumption of the first controlled vehicle 11 and of the following vehicle 15 in relation to the behavior of the first controlled vehicle 11.

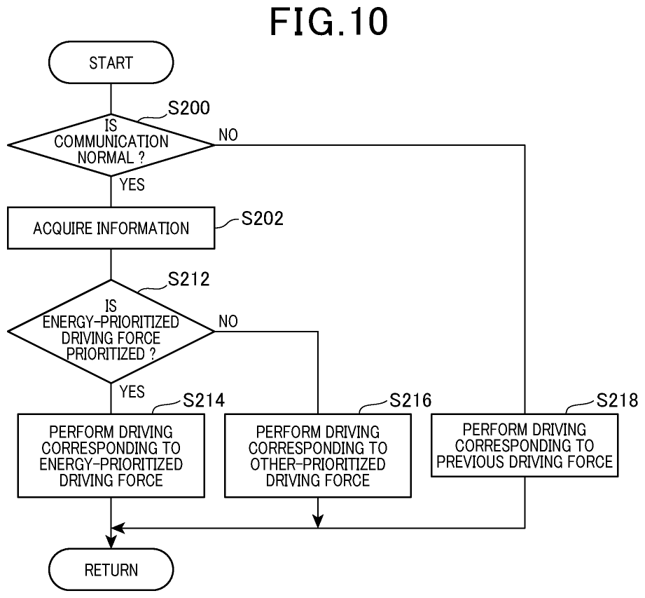

In addition, as shown in a flowchart in FIG. 10, at step S200, the first controlled vehicle 11 determines whether the communication with the communication unit 45 is normal. When the communication between the first controlled vehicle 11 and the communication unit 45 is not normal, that is, when an abnormality has occurred, the process performed by the first controlled vehicle 11 proceeds to step S218. At step S218, the first controlled vehicle 11 behaves as before the occurrence of the abnormality in the communication with the communication unit 45, in a manner similar to that described above. In addition, when the communication between the first controlled vehicle 11 and the communication unit 45 is normal, the process performed by the first controlled vehicle 11 proceeds to step S202.

At step S202 following step S200, the first controlled vehicle 11 acquires the information related to the energy-prioritized driving force and the other-prioritized driving force from the control unit 50.

At step S212 following step S202, the first controlled vehicle 11 selects which of the energy-prioritized driving force and the other-prioritized driving force acquired at step S202 to prioritize. When the energy-prioritized driving force is prioritized, the process performed by the first controlled vehicle 11 proceeds to step S214. In addition, when other-prioritized driving force is prioritized, the process performed by the first controlled vehicle 11 proceeds to step S216.

At step S214 following step S212, the first controlled vehicle 11 performs driving corresponding to the energy-prioritized driving force acquired at step S202. As a result, the first controlled vehicle 11 behaves based on the energy consumption of the first controlled vehicle 11 and of the following vehicle 15 in relation to the behavior of the first controlled vehicle 11. For example, the first controlled vehicle 11 may behave so that the sum of the energy consumption of the first controlled vehicle 11 and of the following vehicle 15 in relation to the behavior of the first controlled vehicle 11 is minimized. Subsequently, the process performed by the first controlled vehicle 11 returns to step S200.

At step S216 following step S212, the first controlled vehicle 11 performs driving corresponding to the other-prioritized driving force acquired at step S202. As a result, the behavior of the first controlled vehicle 11 is changed to behavior corresponding to content differing from the energy consumption of the following vehicle 15 and the first controlled vehicle 11. Subsequently, the process performed by the first controlled vehicle 11 returns to step S200.

Even if the control unit 50 and the first controlled vehicle 11 perform the processes in the above-described manner, effects similar to those according to the first embodiment are achieved.

### Second Embodiment

According to the first embodiment, the control unit 50 causes the first controlled vehicle 11 to behave based on the energy consumption of the first controlled vehicle 11 and of the following vehicle 15 in relation to the behavior of the first controlled vehicle 11. In contrast, according to the second embodiment, the control unit 50 causes the first controlled vehicle 11 to behave based on traffic volume in relation to the behavior of the first controlled vehicle 11. For example, the control unit 50 may cause the first controlled vehicle 11 to behave so that the traffic volume in relation to the behavior of the first controlled vehicle 11 is maximized.

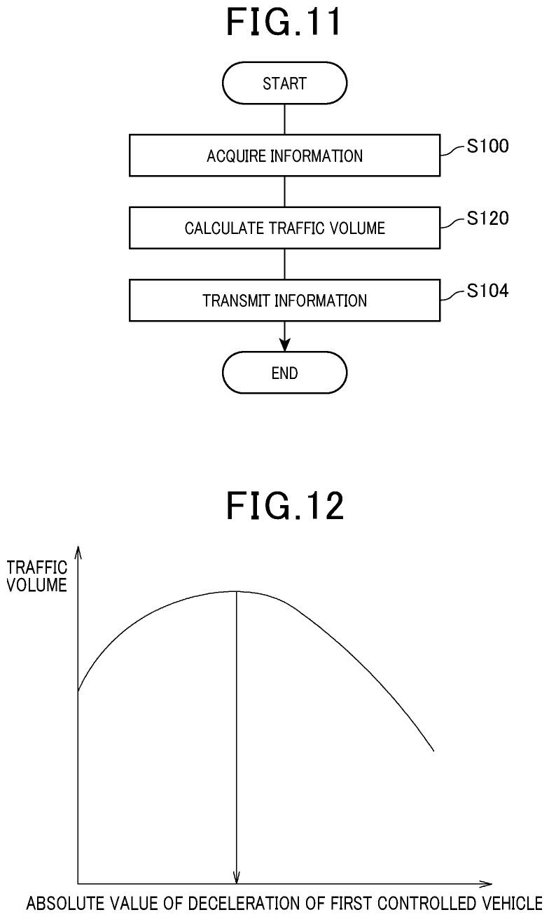

Specifically, as shown in a flowchart in FIG. 11, at step S100, the control unit 50 acquires the information related to the first controlled vehicle 11, the information related to the following vehicle 15, and the information related to the traffic light 20.

At step S120 following step S100, the control unit 50 calculates the traffic volume in relation to the behavior of the first controlled vehicle 11.

For example, the control unit 50 may calculate the relative speed of the following vehicle 15 to the first controlled vehicle 11 from the speed of the first controlled vehicle 11 and the speed of the following vehicle 15 acquired at step S100. The control unit 50 also calculates the average inter-vehicle distance from the traffic density acquired at step S100.

In addition, here, the behavior of the first controlled vehicle 11 is deceleration. The control unit 50 sets the deceleration of the first controlled vehicle 11 to calculate a relationship between the deceleration of the first controlled vehicle 11 and traffic volume, as described hereafter. Furthermore, the control unit 50 calculates the deceleration of the following vehicle 15 using the set deceleration, the calculated relative speed of the following vehicle 15 to the first controlled vehicle 11, the calculated average inter-vehicle distance, and a tracking model.

In addition, the control unit 50 corrects the speed of the following vehicle 15 based on the speed of the following vehicle 15 acquired at step S100, the lighting state of the traffic light 20, the time at which the lighting state changes, and the calculated deceleration of the following vehicle 15. In addition, the control unit 50 corrects the speed of the first controlled vehicle 11 based on the speed of the first controlled vehicle 11 acquired at step S100, the lighting state of the traffic light 20 and the time at which the lighting state changes, and the set deceleration of the first controlled vehicle 11.

Furthermore, the control unit 50 calculates a harmonic mean of the corrected speeds of the following vehicle 15 and the first controlled vehicle 11.

The control unit 50 then multiplies the calculated harmonic-mean speed by the traffic density acquired at step S100. The control unit 50 thereby calculates the traffic volume. In addition, the control unit 50 changes the deceleration of the first controlled vehicle 11 and calculates the traffic volume for each deceleration of the first controlled vehicle 11. The control unit 50 thereby calculates the traffic volume relative to the deceleration of the first controlled vehicle 11 as shown in FIG. 12. As a result, the control unit 50 calculates the traffic volume in relation to the behavior of the first controlled vehicle 11.

At step S104 following step S120, the control unit 50 transmits the information related to the following vehicle 15 and the information related to the traffic light 20 acquired at step S100 to the first controlled vehicle 11 through the communication unit 45. In addition, the control unit 50 transmits the traffic volume in relation to the behavior of the first controlled vehicle 11 calculated at step S120 to the first controlled vehicle 11 through the communication unit 45. As a result, the control unit 50 causes the first controlled vehicle 11 to behave based on the traffic volume in relation to the behavior of the first controlled vehicle 11. Subsequently, the process performed by the control unit 50 is ended.

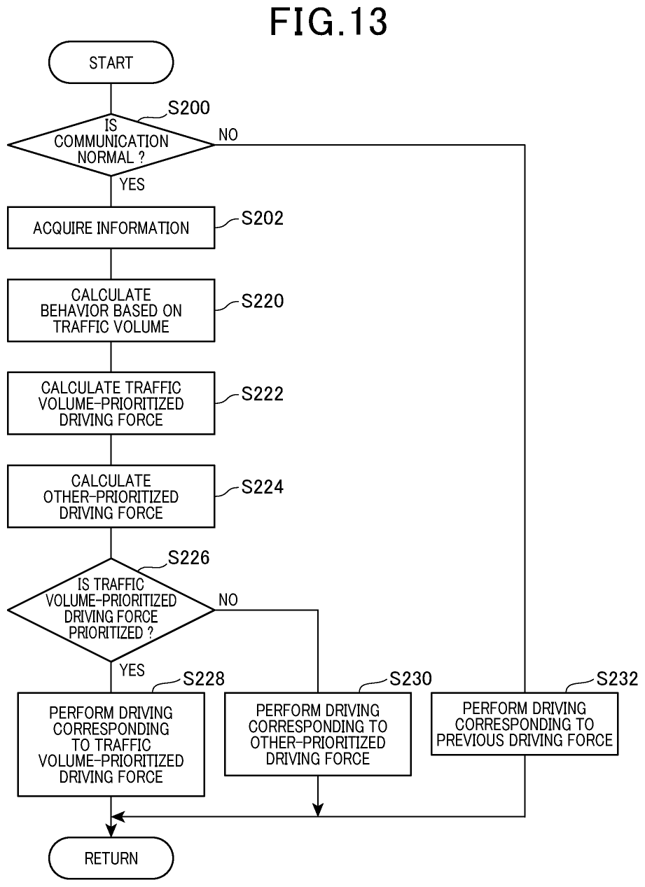

As described above, the control unit 50 generates information to cause the first controlled vehicle 11 to behave based on the traffic volume in relation to the behavior of the first controlled vehicle 11, based on the information related to the first controlled vehicle 11, the following vehicle 15, and the traffic light 20. Next, the behavior of the first controlled vehicle 11 as a result of the first controlled vehicle 11 implementing a program will be explained with reference to a flowchart in FIG. 13.

At step S200, the first controlled vehicle 11 determines whether the communication with the communication unit 45 is normal. When the communication between the first controlled vehicle 11 and the communication unit 45 is not normal, that is, when an abnormality has occurred, the process performed by the first controlled vehicle 11 proceeds to step S232. In addition, when the communication with the communication unit 45 is normal, the process performed by the first controlled vehicle 11 proceeds to step S202.

At step S202 following step S200, the first controlled vehicle 11 acquires the information related to the following vehicle 15, the information related to the traffic light 20, and the traffic volume in relation to the behavior of the first controlled vehicle 11 from the control unit 50. The first controlled vehicle 11 also acquires the information related to the first controlled vehicle 11 from the sensor group of the first controlled vehicle 11.

At step S220 following step S202, the first controlled vehicle 11 calculates behavior based on the traffic volume in relation to the behavior of the first controlled vehicle 11. For example, here, the first controlled vehicle 11 may calculate behavior by which the traffic volume in relation to the behavior of the first controlled vehicle 11 is maximized.

Specifically, as shown in FIG. 12, the first controlled vehicle 11 calculates the deceleration of the first controlled vehicle 11 at which the traffic volume in relation to the behavior of the first controlled vehicle 11 is maximized from the traffic volume in relation to the behavior of the first controlled vehicle 11 acquired at step S202. The first controlled vehicle 11 thereby calculates the behavior by which the traffic volume in relation to the behavior of the first controlled vehicle 11 is maximized.

Returning to FIG. 13, next, at step S222, the first controlled vehicle 11 calculates driving force corresponding to the behavior based on the traffic volume in relation to the behavior of the first controlled vehicle 11 calculated at step S220. Hereafter, the driving force corresponding to the behavior based on the traffic volume in relation to the behavior of the first controlled vehicle 11 will be referred to as traffic volume-prioritized driving force.

For example, the first controlled vehicle 11 may calculate the traffic volume-prioritized driving force using the deceleration of the first controlled vehicle 11 at which the traffic volume in relation to the behavior of the first controlled vehicle 11 is maximized and a map. Here, the map for calculating the traffic volume-prioritized driving force is set through experiments, simulations, and the like.

Next, at step S224, the first controlled vehicle 11 calculates driving force corresponding to content differing from traffic volume from the information acquired at step S202. Here, the driving force corresponding to content differing from traffic volume will be referred to as other-prioritized driving force.

For example, the content differing from traffic volume may be the energy consumption of the following vehicle 15 and the first controlled vehicle 11. In this case, the first controlled vehicle 11 calculates the energy consumption of the following vehicle 15 and the first controlled vehicle 11 relative to the deceleration of the first controlled vehicle 11, in a manner similar to that described above.

In addition, the first controlled vehicle 11 calculates the deceleration of the first controlled vehicle 11 at which the sum of the energy consumption of the following vehicle 15 and the first controlled vehicle 11 is minimized from the calculated energy consumption of the following vehicle 15 and the first controlled vehicle 11 relative to the deceleration of the first controlled vehicle 11. The first controlled vehicle 11 also calculates the other-prioritized driving force from the calculated deceleration and a map. Here, the map for calculating the other-prioritized driving force is set through experiments, simulations, and the like.

In addition, for example, the content differing from traffic volume may be the drivability of the first controlled vehicle 11. In this case, for example, the first controlled vehicle 11 may calculate a value related to the drivability of the first controlled vehicle 11 from the deceleration of the first controlled vehicle 11 and a map. Furthermore, the first controlled vehicle 11 changes the deceleration of the first controlled vehicle 11 and calculates the value related to the drivability of the first controlled vehicle 11 for each deceleration of the first controlled vehicle 11. The first controlled vehicle 11 thereby calculates the value related to the drivability of the first controlled vehicle 11 relative to the deceleration of the first controlled vehicle 11. Here, the map for the value related to drivability is set through experiments, simulations, and the like.

The first controlled vehicle 11 also calculates deceleration of the first controlled vehicle 11 at which the value related to the drivability of the first controlled vehicle 11 is maximized from on the calculated value related to the drivability of the first controlled vehicle 11 relative to the deceleration of the first controlled vehicle 11. The first controlled vehicle 11 also calculates the other-prioritized driving force from the calculated deceleration and a map.

In addition, for example, the content differing from traffic volume may be safety of the first controlled vehicle 11 and its surroundings. In this case, for example, the first controlled vehicle 11 may calculate a value related to safety based on a distance from the first controlled vehicle 11 to a surrounding object and a relative speed of the surrounding object to the first controlled vehicle 11 acquired from the sensor group of the first controlled vehicle 11, and a map. In addition, the first controlled vehicle 11 changes the deceleration of the first controlled vehicle 11 and calculates the value related to safety for each deceleration of the first controlled vehicle 11. The first controlled vehicle 11 thereby calculates the value related to safety relative to the deceleration of the first controlled vehicle 11.

The first controlled vehicle 11 also calculates the deceleration of the first controlled vehicle 11 at which the value related to safety is maximized from the calculated value related to safety relative to the deceleration of the first controlled vehicle 11. The first controlled vehicle 11 also calculates the other-prioritized driving force from the calculated deceleration and a map.

Next, at step S226, the first controlled vehicle 11 selects which of the traffic volume-prioritized driving force calculated at step S222 and the other-prioritized driving force calculated at step S224 to prioritize.

For example, the first controlled vehicle 11 may compare the traffic volume-prioritized driving force and the other-prioritized driving force in a manner similar to that described above. The first controlled vehicle 11 thereby selects which of the traffic volume-prioritized driving force and the other-prioritized driving force to prioritize. In addition, when the traffic volume-prioritized driving force is equal to or less than the other-prioritized driving force, the first controlled vehicle 11 prioritizes the traffic volume-prioritized driving force. Subsequently, the process performed by the first controlled vehicle 11 proceeds to step S228. Furthermore, when the traffic volume-prioritized driving force is greater than the other-prioritized driving force, the first controlled vehicle 11 prioritizes the other-prioritized driving force. Subsequently, the process performed by the first controlled vehicle 11 proceeds to step S230.

At step S228 following step S226, the first controlled vehicle 11 performs driving corresponding to the traffic volume-prioritized driving force calculated at step S222. As a result, the first controlled vehicle 11 behaves based on traffic volume in relation to the behavior of the first controlled vehicle 11. Here, the first controlled vehicle 11 behaves so that the traffic volume in relation to the behavior of the first controlled vehicle 11 is maximized. Subsequently, the process performed by the first controlled vehicle 11 returns to step S200.

At step S230 following step S226, the first controlled vehicle 11 performs driving corresponding to the other-prioritized driving force calculated at step S224. As a result, the behavior of the first controlled vehicle 11 is changed to the behavior based on content differing from traffic volume.

For example, when the content differing from traffic volume may be the energy consumption of the following vehicle 15 and the first controlled vehicle 11, the first controlled vehicle 11 may behave so that the sum of the energy consumption of the following vehicle 15 and the first controlled vehicle 11 is minimized. Here, at this time, the first controlled vehicle 11 may behave so that the energy consumption of the following vehicle 15 is minimized instead of the sum of the energy consumption of the following vehicle 15 and the first controlled vehicle 11. Furthermore, the first controlled vehicle 11 may behave so that the energy consumption of the first controlled vehicle 11 is minimized.

In addition, for example, when the content differing from the energy consumption of the following vehicle 15 and the first controlled vehicle 11 may be the drivability of the first controlled vehicle 11, the first controlled vehicle 11 may behave so that the value related to the drivability of the first controlled vehicle 11 is maximized. Furthermore, for example, when the content differing from the energy consumption of the following vehicle 15 and the first controlled vehicle 11 may be safety of the first controlled vehicle 11 and its surroundings, the first controlled vehicle 11 may behave so that the value related to safety is maximized. Subsequently, the process performed by the first controlled vehicle 11 returns to step S200.

At step S232 following step S200, an abnormality has occurred in the communication between the first controlled vehicle 11 and the communication unit 45. At this time, the first controlled vehicle 11 cannot acquire, from the control unit 50, the information related to the following vehicle 15, the information related to the traffic light 20, and the traffic volume in relation to the behavior of the first controlled vehicle 11. Therefore, the first controlled vehicle 11 behaves as before the occurrence of an abnormality in the communication with the communication unit 45. For example, the first controlled vehicle 11 may behave based on traffic volume in relation to the behavior of the first controlled vehicle 11 calculated before the occurrence of an abnormality in the communication with the communication unit 45. As a result, even if an abnormality occurs in the communication with the communication unit 45, the first controlled vehicle 11 can continue to behave based on traffic volume in relation to the behavior of the first controlled vehicle 11. Subsequently, the process performed by the first controlled vehicle 11 returns to step S200. Here, when an abnormality occurs in the communication with the communication unit 45, the first controlled vehicle 11 may behave so that energy consumption of the following vehicle 15 and the first controlled vehicle 11 before the occurrence of an abnormality in the communication with the communication unit 45 is minimized. In addition, when an abnormality occurs in the communication with the communication unit 45, the first controlled vehicle 11 may behave so that the value related to drivability or the value related to safety of the first controlled vehicle 11 before the occurrence of an abnormality in the communication with the communication unit 45 is maximized.

The first controlled vehicle 11 performs the process as described above. Next, the traffic flow control apparatus 40 according to the second embodiment achieves the following effects.

[2] In the vehicle driving assistance system described in JP 2008-299666 A, a following vehicle traveling behind an own vehicle may perform unnecessary acceleration/deceleration depending on the acceleration/deceleration of the own vehicle. As a result, traffic volume of a traffic flow on a road on which the own vehicle and the following vehicle 15 travel is reduced.

In contrast, in the traffic flow control apparatus 40 according to the second embodiment, the control unit 50 functions as an acquiring unit that acquires the information related to the first controlled vehicle 11, the information related to the following vehicle 15, and the information related to the traffic light 20. In addition, the control unit 50 causes the first controlled vehicle 11 to behave based on the traffic volume in relation to the behavior of the first controlled vehicle 11 acquired from the acquired information. For example, the control unit 50 may cause the first controlled vehicle 11 to behave so that the traffic volume in relation to the behavior of the first controlled vehicle 11 is maximized. Furthermore, for example, here, the traffic volume in relation to the behavior of the first controlled vehicle 11 may be calculated at step S120 by the control unit 50. Also, behavior based on the traffic volume in relation to the behavior of the first controlled vehicle 11 is calculated at step S220 by the first controlled vehicle 11. At step S228, the first controlled vehicle 11 behaves based on the traffic volume in relation to the behavior of the first controlled vehicle 11. In addition, the behavior based on the energy consumption of the first controlled vehicle 11 and of the following vehicle 15 in relation to the behavior of the first controlled vehicle 11 may be, for example, deceleration.

As a result, because the first controlled vehicle 11 behaves based on the traffic volume, decrease in traffic volume in the traffic flow on the road on which the first controlled vehicle 11 and the following vehicle 15 travel is suppressed. Furthermore, according to the second embodiment, effects similar to those described in [1-1], [1-2], and [1-3] above are achieved.

### Modification 1 According to the Second Embodiment

According to the above-described second embodiment, the traffic volume relative to the deceleration of the first controlled vehicle 11 is calculated as the traffic volume in relation to the behavior of the first controlled vehicle 11. In contrast, as the traffic volume in relation to the behavior of the first controlled vehicle 11, the traffic volume relative to the deceleration timing of the first controlled vehicle 11 may be calculated. Even in such a case, effects similar to those according to the second embodiment can be achieved.

### Modification 2 According to the Second Embodiment

According to the above-described second embodiment, at steps S220 to S224, the first controlled vehicle 11 calculates behavior based on traffic volume, the traffic volume-prioritized driving force, and the other-prioritized driving force. In contrast, instead of the first controlled vehicle 11, the control unit 50 may calculate behavior based on traffic volume, the traffic volume-prioritized driving force, and the other-prioritized driving force.

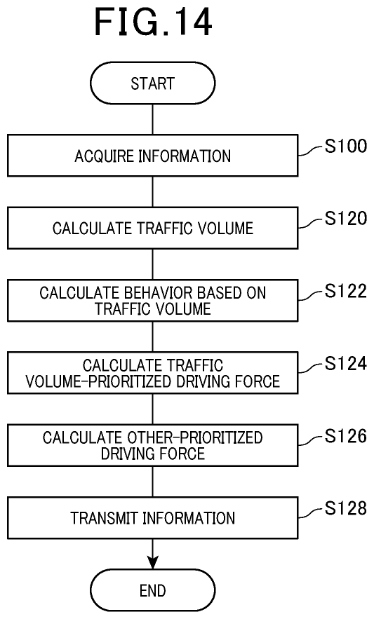

Specifically, as shown in a flowchart in FIG. 14, at step S100, the control unit 50 acquires the information related to the first controlled vehicle 11, the information related to the following vehicle 15, and the information related to the traffic light 20 in a manner similar to that described above. At step S120 following step S100, the control unit 50 calculates traffic volume in relation to the behavior of the first controlled vehicle 11, in a manner similar to that described above.

At step S122 following step S120, the control unit 50 calculates behavior based on traffic volume in relation to the behavior of the first controlled vehicle 11, in a manner similar to the process at step S220 by the first controlled vehicle 11. For example, the control unit 50 may calculate behavior by which the traffic volume in relation to the behavior of the first controlled vehicle 11 is maximized.

Next, at step S124, the control unit 50 calculates the traffic volume-prioritized driving force in manner similar to the process at step S222 by the first controlled vehicle 11. Next, at step S126, the control unit 50 calculates the other-prioritized driving force in manner similar to the process at step S224 by the first controlled vehicle 11.

Next, at step S128, the control unit 50 transmits information related to the traffic volume-prioritized driving force calculated at step S124 and the other-prioritized driving force calculated at step S126 to the first controlled vehicle 11 through the communication unit 45. As a result, the control unit 50 causes the first controlled vehicle 11 to behave based on the traffic volume in relation to the behavior of the first controlled vehicle 11.

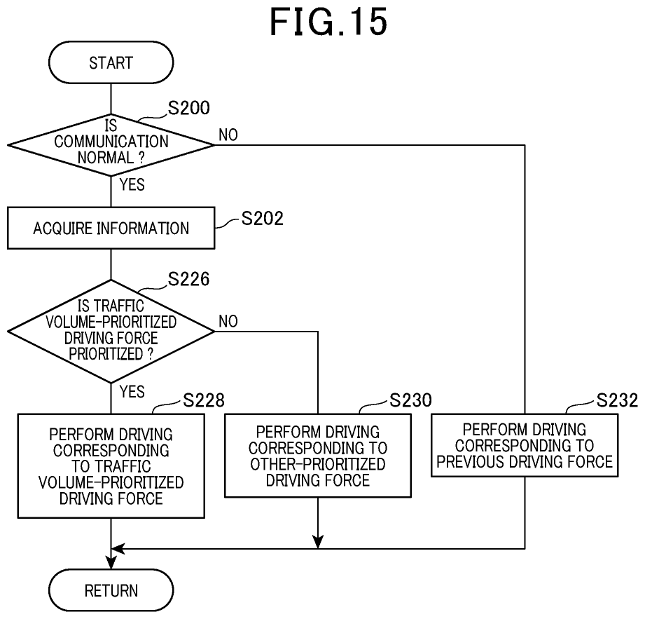

In addition, as shown in a flowchart in FIG. 15, at step S200, the first controlled vehicle 11 determines whether communication with the communication unit 45 is normal. When the communication between the first controlled vehicle 11 and the communication unit 45 is not normal, that is, when an abnormality has occurred, the process performed by the first controlled vehicle 11 proceeds to step S232. At step S232, the first controlled vehicle 11 behaves as before the occurrence of an abnormality in the communication with the communication unit 45, in a manner similar to that described above. In addition, when the communication between the first controlled vehicle 11 and the communication unit 45 is normal, the process performed by the first controlled vehicle 11 proceeds to step S202.

At step S202 following step S200, the first controlled vehicle 11 acquires information related to the traffic volume-prioritized driving force and other-prioritized driving force from the control unit 50.

At step S226 following step S202, the first controlled vehicle 11 selects which of the traffic volume-prioritized driving force and other-prioritized driving force acquired at step S202 to prioritize. When the traffic volume-prioritized driving force is prioritized, the process performed by the first controlled vehicle 11 proceeds to step S228. In addition, when the other-prioritized driving force is prioritized, the process performed by the first controlled vehicle 11 proceeds to step S230.

At step S228 following step S226, the first controlled vehicle 11 performs driving corresponding to the traffic volume-prioritized driving force acquired at step S202. The first controlled vehicle 11 thereby behaves based on traffic volume in relation to the behavior of the first controlled vehicle 11. For example, the first controlled vehicle 11 may behave so that the traffic volume in relation to the behavior of the first controlled vehicle 11 is maximized. Subsequently, the process performed by the first controlled vehicle 11 returns to step S200.

At step S230 following step S226, the first controlled vehicle 11 performs driving corresponding to the other-prioritized driving force acquired at step S202. As a result, the behavior of the first controlled vehicle 11 is changed to the behavior based on content differing from the traffic volume. Subsequently, the process performed by the first controlled vehicle 11 returns to step S200.

Even if the control unit 50 and the first controlled vehicle 11 perform the processes in the above-described manner, effects similar to those according to the second embodiment are achieved.

### OTHER EMBODIMENTS

The present disclosure is not limited to the embodiments described above. The embodiments can be modified as appropriate. Furthermore, in each of the above embodiments, it goes without saying that an element that configures an embodiment is not necessarily a requisite unless particularly specified as being a requisite, clearly considered a requisite in principle, or the like.

The acquiring unit, the control unit, and a method thereof described in the present disclosure may be actualized by a dedicated computer that is provided such as to be configured by a processor and a memory, the processor being programmed to provide one or a plurality of functions that are realized by a computer program. Alternatively, the acquiring unit, the control unit, and a method thereof described in the present disclosure may be actualized by a dedicated computer that is provided by a processor being configured by a single dedicated hardware logic circuit or more. Still alternatively, the acquiring unit, the control unit, and a method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible, computer-readable storage medium that can be read by a computer as instructions performed by the computer.

According to the above-described embodiments, deceleration of the first controlled vehicle 11 is given as the behavior of the first controlled vehicle 11. In contrast, the behavior of the first controlled vehicle 11 is not limited to deceleration of the first controlled vehicle 11 and may be acceleration of the first controlled vehicle 11

Specifically, the first controlled vehicle 11 may behave based on the energy consumption of the first controlled vehicle 11 and of the following vehicle 15 relative to acceleration, acceleration timing, and the like of the first controlled vehicle 11. For example, the first controlled vehicle 11 may behave so that the sum of the energy consumption of the first controlled vehicle 11 and of the following vehicle 15 relative to the acceleration, acceleration timing, and the like of the first controlled vehicle 11 is minimized.

In addition, the first controlled vehicle 11 may behave based on traffic volume relative to the acceleration, acceleration timing, and the like of the first controlled vehicle 11. For example, the first controlled vehicle 11 may behave so that the traffic volume relative to the acceleration, acceleration timing, and the like of the first controlled vehicle 11 is maximized.

Furthermore, the behavior of the first controlled vehicle 11 may be changed to behavior based on drivability relative to the acceleration, acceleration timing, and the like of the first controlled vehicle 11. For example, the behavior of the first controlled vehicle 11 may be changed to behavior in which a value related to drivability relative to the acceleration, acceleration timing, and the like of the first controlled vehicle 11 is maximized.

Moreover, the behavior of the first controlled vehicle 11 may be changed to behavior based on safety of the first controlled vehicle 11 and its surroundings relative to the acceleration, acceleration timing, and the like of the first controlled vehicle 11. For example, the behavior of the first controlled vehicle 11 may be changed to behavior in which a value related to safety relative to the acceleration, acceleration timing, and the like of the first controlled vehicle 11 is maximized.

According to the above-described embodiments, the traffic light 20 is given as a forward object positioned in front of the first controlled vehicle 11. In contrast, the forward object is not limited to the traffic light 20, and may be a stationary object such as a railroad crossing or a road sign, or a wall on the road such as a guide rail. Furthermore, the forward object may be a moving object such as a vehicle or a pedestrian crossing the road.

According to the above-described first embodiment, the behavior by which the sum of the energy consumption of the first controlled vehicle 11 and of the following vehicle 15 in relation to the behavior of the first controlled vehicle 11 is minimized is given as the behavior based on the energy consumption of the first controlled vehicle 11 and of the following vehicle 15 in relation to the behavior of the first controlled vehicle 11. In contrast, the behavior based on the energy consumption of the first controlled vehicle 11 and of the following vehicle 15 in relation to the behavior of the first controlled vehicle 11 is not limited to the behavior by which the sum of the energy consumption of the first controlled vehicle 11 and of the following vehicle 15 in relation to the behavior of the first controlled vehicle 11 is minimized.

For example, the behavior based on the energy consumption of the first controlled vehicle 11 and of the following vehicle 15 in relation to the behavior of the first controlled vehicle 11 may be behavior by which the energy consumption is less than the energy consumption of the first controlled vehicle 11 and of the following vehicle 15 in relation to the behavior of the first controlled vehicle 11 at a current time.

In addition, the behavior based on the energy consumption of the first controlled vehicle 11 and of the following vehicle 15 in relation to the behavior of the first controlled vehicle 11 may be a change in lane or route of the first controlled vehicle 11, or the like. For example, when the current energy consumption of the first controlled vehicle 11 and of the following vehicle 15 may be equal to or greater than a threshold, the traffic flow control apparatus 40 may output a signal to the first controlled vehicle 11 to change the lane and route of the first controlled vehicle 11. As a result, the first controlled vehicle 11 changes the lane and route on which the first controlled vehicle 11 is currently traveling to a lane and route by which the energy consumption of the first controlled vehicle 11 and of the following vehicle 15 is reduced. Therefore, an increase in the energy consumption of the first controlled vehicle 11 and of the following vehicle 15 is suppressed. Here, the threshold related to the energy consumption is set by experiments or simulations so that the lane and route of the first controlled vehicle 11 are changed.

According to the above-described second embodiment, the behavior by which traffic volume in relation to the behavior of the first controlled vehicle 11 is maximum is given as the behavior based on traffic volume in relation to the behavior of the first controlled vehicle 11. In contrast, the behavior based on traffic volume in relation to the behavior of the first controlled vehicle 11 is not limited to the behavior in which the traffic volume in relation to the behavior of the first controlled vehicle 11 is maximum.

For example, the behavior based on traffic volume in relation to the behavior of the first controlled vehicle 11 may be behavior by which the traffic volume is greater than the traffic volume in relation to the behavior of the first controlled vehicle 11 at the current time.

In addition, the behavior based on traffic volume in relation to the behavior of the first controlled vehicle 11 may be a change in the lane and route of the first controlled vehicle 11 or the like. For example, when the current traffic volume of the first controlled vehicle 11 and the following vehicle 15 may be less than a threshold, the traffic flow control apparatus 40 may output a signal to the first controlled vehicle 11 to change the lane and route of the first controlled vehicle 11. As a result, the first controlled vehicle 11 changes the lane and route on which the first controlled vehicle 11 is currently traveling to a lane and route by which traffic volume is increased. Here, the threshold related to traffic volume is set by experiments or simulations so that the lane and route of the first controlled vehicle 11 are changed.

According to the above-described embodiments, the first controlled vehicle 11 is controlled by the traffic flow control apparatus 40. In contrast, a second controlled vehicle 12 may be controlled by the traffic flow control apparatus 40 in a similar manner as the first controlled vehicle 11.

Furthermore, the traffic flow control apparatus 40 may control the traffic light 20 and the like based on the information related to the first controlled vehicle 11, the information related to the following vehicle 15, and the information related to the traffic lights 20. For example, the light of the traffic light 20 on the road on which the first controlled vehicle 11 and the following vehicle 15 travel may be assumed to be green in a case in which the calculated energy consumption of the first controlled vehicle 11 and of the following vehicle 15 is equal to or greater than the threshold. At this time, the traffic flow control apparatus 40 may extend the time over which the traffic light 20 is green. As a result, the first controlled vehicle 11 and the following vehicle 15 can more easily pass through the traffic light 20. Therefore, unnecessary acceleration/deceleration of the first controlled vehicle 11 and the following vehicle 15 is suppressed. Increase in the energy consumption of the first controlled vehicle 11 and of the following vehicle 15 is thereby suppressed. Furthermore, decrease in traffic volume on the road on which the first controlled vehicle 11 and the following vehicle 15 travel is suppressed. Here, the threshold related to energy consumption is set by experiments or simulations so that calculation is such that the energy consumption of the first controlled vehicle 11 and of the following vehicle 15 is relatively large.

According to the above-described embodiments, the traffic flow control apparatus 40 is disposed in a different location from the first controlled vehicle 11, the second controlled vehicle 12, and the following vehicle 15. However, this is not limited thereto. The traffic flow control apparatus 40 may be disposed in the first controlled vehicle 11 and the second controlled vehicle 12.

### ASPECTS OF THE PRESENT DISCLOSURE

As is clear from the description of the embodiments above, the disclosure according to the present specification includes at least the following aspects.

### Technical Problem

In the vehicle driving assistance system described in JP 2008-299666 A, a following vehicle traveling behind an own vehicle may unnecessarily accelerate/decelerate in response to the acceleration/deceleration of the own vehicle. As a result, the own vehicle and the following vehicle waste fuel and electrical energy. Consequently, energy consumption in the traffic flow on the road on which the own vehicle and the following vehicle travel increases.

### [Aspect 1-1]

A traffic flow control apparatus includes: a communication unit (45); an acquiring unit (50) that acquires information related to a first controlled vehicle (11) that communicates with the communication unit, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and a control unit (50) that causes the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.

### [Aspect 1-2]

The traffic flow control apparatus according to aspect 1-1, in which: the control unit causes the first controlled vehicle to behave so that a sum of the energy consumption of the first controlled vehicle and of the following vehicle in relation to the behavior of the first controlled vehicle is minimized.

### [Aspect 1-3]

The traffic flow control apparatus according to aspect 1-1 or 1-2, in which: the communication unit, the acquiring unit, and the control unit are disposed in a different location from the first controlled vehicle, the second controlled vehicle, and the following vehicle.

### [Aspect 1-4]

The traffic flow control apparatus according to any one of aspects 1-1 to 1-3, in which: the first controlled vehicle changes the behavior of the first controlled vehicle based on traffic volume in relation to the behavior of the first controlled vehicle, the traffic volume being a number of vehicles passing through a certain point per unit time.

### [Aspect 1-5]

The traffic flow control apparatus according to any one of aspects 1-1 to 1-4, in which: the first controlled vehicle changes the behavior of the first controlled vehicle based on a value related to drivability of the first controlled vehicle.

### [Aspect 1-6]

The traffic flow control apparatus according to any one of aspects 1-1 to 1-5, in which: the first controlled vehicle changes the behavior of the first controlled vehicle based on a value related to safety of the first controlled vehicle.

### [Aspect 1-7]

The traffic flow control apparatus according to any one of aspects 1-1 to 1-6, in which: the behavior of the first controlled vehicle based on the energy consumption of the first controlled vehicle and of the following vehicle in relation to the behavior of the first controlled vehicle is deceleration.

### [Aspect 1-8]

The traffic flow control apparatus according to any one of aspects 1-1 to 1-7, in which: the forward object is a traffic light.

### [Aspect 1-9]

The traffic flow control apparatus according to any one of aspects 1-1 to 1-8, in which: when an abnormality occurs in the communication with the communication unit, the first controlled vehicle behaves based on the energy consumption of the first controlled vehicle and of the following vehicle in relation to the behavior of the first controlled vehicle before the occurrence of an abnormality in the communication with the communication unit.

### [Aspect 1-10]

The traffic flow control apparatus according to any one of aspects 1-1 to 1-9, in which: the information related to the following vehicle includes a type of the following vehicle.

### [Aspect 1-11]

A non-transitory computer-readable storage medium storing a traffic flow control program that causes a computer to implement: acquiring information related to a first controlled vehicle (11) that communicates with a communication unit (45) of the traffic flow control apparatus, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and causing the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.

### [Aspect 1-12]

A traffic flow control method includes: acquiring information related to a first controlled vehicle (11) that communicates with the communication unit, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and causing the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.

### Technical Problem

In the vehicle driving assistance system described in JP 2008-299666 A, a following vehicle traveling behind an own vehicle may unnecessarily accelerate/decelerate in response to the acceleration/deceleration of the own vehicle. As a result, traffic volume of a traffic flow on a road on which the own vehicle and the following vehicle travel decreases.

### [Aspect 2-1]

A traffic flow control apparatus includes: a communication unit (45); an acquiring unit (50) that acquires information related to a first controlled vehicle (11) that communicates with the communication unit, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and a control unit (50) that causes the first controlled vehicle to behave based on traffic volume in relation to the behavior of the first controlled vehicle, the traffic volume being acquired from the information related to the first controlled vehicle, the information related to the following vehicle, and the information related to the forward object, the traffic volume being a number of vehicles passing through a certain point per unit time.

### [Aspect 2-2]

The traffic flow control apparatus according to aspect 2-1, in which: the control unit causes the first controlled vehicle to behave so that traffic volume in relation to the behavior of the first controlled vehicle is maximized.

### [Aspect 2-3]

The traffic flow control apparatus according to aspect 2-1 or 2-2, in which: the communication unit, the acquiring unit, and the control unit are disposed in a different location from the first controlled vehicle, the second controlled vehicle, and the following vehicle.

### [Aspect 2-4]

The traffic flow control apparatus according to any one of aspects 2-1 to 2-3, in which: the first controlled vehicle changes the behavior of the first controlled vehicle based on energy consumption of the following vehicle in relation to the behavior of the first controlled vehicle.

### [Aspect 2-5]

The traffic flow control apparatus according to any one of aspects 2-1 to 2-4, in which: the first controlled vehicle changes the behavior of the first controlled vehicle based on energy consumption of the first controlled vehicle in relation to the behavior of the first controlled vehicle.

### [Aspect 2-6]

The traffic flow control apparatus according to any one of aspects 2-1 to 2-5, in which: the first controlled vehicle changes the behavior of the first controlled vehicle based on a value related to drivability of the first controlled vehicle.

### [Aspect 2-7]

The traffic flow control apparatus according to any one of aspects 2-1 to 2-6, in which: the first controlled vehicle changes the behavior of the first controlled vehicle based on a value related to safety of the first controlled vehicle.

### [Aspect 2-8]

The traffic flow control apparatus according to any one of aspects 2-1 to 2-7, in which: the behavior of the first controlled vehicle based on traffic volume in relation to the behavior of the first controlled vehicle is deceleration.

### [Aspect 2-9]

The traffic flow control apparatus according to any one of aspects 2-1 to 2-8, in which: the forward object is a traffic light.

### [Aspect 2-10]

The traffic flow control apparatus according to any one of aspects 2-1 to 2-9, in which: when an abnormality occurs in the communication with the communication unit, the first controlled vehicle behaves based on traffic volume in relation to the behavior of the first controlled vehicle before the occurrence of an abnormality in the communication with the communication unit.

### [Aspect 2-11]

A non-transitory computer-readable storage medium storing a traffic flow control program that causes a computer to implement: acquiring information related to a first controlled vehicle (11) that communicates with a communication unit (45) of the traffic flow control apparatus, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and causing the first controlled vehicle to behave based on traffic volume in relation to behavior of the first controlled vehicle, the traffic volume being acquired from the information related to the first controlled vehicle, the information related to the following vehicle, and the information related to the forward object, the traffic volume being a number of vehicles passing through a certain point per unit time.

### [Aspect 2-12]

A traffic flow control method includes: acquiring information related to a first controlled vehicle (11) that communicates with the communication unit, information related to a following vehicle (15) that travels between the first controlled vehicle and a second controlled vehicle (12) that travels behind the first controlled vehicle and communicates with the communication unit, and information related to a forward object (20) that is positioned ahead of the first controlled vehicle; and causing the first controlled vehicle to behave based on traffic volume in relation to the behavior of the first controlled vehicle, the traffic volume being acquired from the information related to the first controlled vehicle, the information related to the following vehicle, and the information related to the forward object, the traffic volume being a number of vehicles passing through a certain point per unit time.

What is claimed is:

1. A traffic flow control apparatus comprising:
a communication unit;
an acquiring unit that acquires information related to a first controlled vehicle that communicates with the communication unit, information related to a following vehicle that travels between the first controlled vehicle and a second controlled vehicle that travels behind the first controlled vehicle and communicates with the communication unit, and information related to a forward object that is positioned ahead of the first controlled vehicle; and
a control unit that causes the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.

2. The traffic flow control apparatus according to claim 1, wherein:
the control unit causes the first controlled vehicle to behave so that a sum of the energy consumption of the first controlled vehicle and of the following vehicle in relation to the behavior of the first controlled vehicle is minimized.

3. The traffic flow control apparatus according to claim 1, wherein:
the communication unit, the acquiring unit, and the control unit are disposed in a different location from the first controlled vehicle, the second controlled vehicle, and the following vehicle.

4. The traffic flow control apparatus according to claim 1, wherein:
the first controlled vehicle changes the behavior of the first controlled vehicle based on traffic volume in relation to the behavior of the first controlled vehicle, the traffic volume being a number of vehicles passing through a certain point per unit time.

5. The traffic flow control apparatus according to claim 1, wherein:
the first controlled vehicle changes the behavior of the first controlled vehicle based on a value related to drivability of the first controlled vehicle.

6. The traffic flow control apparatus according to claim 1, wherein:
the first controlled vehicle changes the behavior of the first controlled vehicle based on a value related to safety of the first controlled vehicle.

7. The traffic flow control apparatus according to claim 1, wherein:
the behavior of the first controlled vehicle based on energy consumption of the first controlled vehicle and of the following vehicle in relation to the behavior of the first controlled vehicle is deceleration.

8. The traffic flow control apparatus according to claim 1, wherein:
the forward object is a traffic light.

9. The traffic flow control apparatus according to claim 1, wherein:
when an abnormality occurs in the communication with the communication unit, the first controlled vehicle behaves based on the energy consumption of the first controlled vehicle and of the following vehicle in relation to the behavior of the first controlled vehicle before the occurrence of an abnormality in the communication with the communication unit.

10. The traffic flow control apparatus according to claim 1, wherein:
the information related to the following vehicle includes a type of the following vehicle.

11. The traffic flow control apparatus according to claim 2, wherein:
the communication unit, the acquiring unit, and the control unit are disposed in a different location from the first controlled vehicle, the second controlled vehicle, and the following vehicle.

12. The traffic flow control apparatus according to claim 2, wherein:
the first controlled vehicle changes the behavior of the first controlled vehicle based on traffic volume in relation to the behavior of the first controlled vehicle, the traffic volume being a number of vehicles passing through a certain point per unit time.

13. The traffic flow control apparatus according to claim 2, wherein:
the first controlled vehicle changes the behavior of the first controlled vehicle based on a value related to drivability of the first controlled vehicle.

14. The traffic flow control apparatus according to claim 2, wherein:
the first controlled vehicle changes the behavior of the first controlled vehicle based on a value related to safety of the first controlled vehicle.

15. The traffic flow control apparatus according to claim 2, wherein:
the behavior of the first controlled vehicle based on energy consumption of the first controlled vehicle and of the following vehicle in relation to the behavior of the first controlled vehicle is deceleration.

16. The traffic flow control apparatus according to claim 2, wherein:
the forward object is a traffic light.

17. The traffic flow control apparatus according to claim 2, wherein:
when an abnormality occurs in the communication with the communication unit, the first controlled vehicle behaves based on the energy consumption of the first controlled vehicle and of the following vehicle in relation to the behavior of the first controlled vehicle before the occurrence of an abnormality in the communication with the communication unit.

18. The traffic flow control apparatus according to claim 2, wherein:
the information related to the following vehicle includes a type of the following vehicle.

19. A non-transitory computer-readable storage medium storing a traffic flow control program for causing a computer to implement:
acquiring information related to a first controlled vehicle that communicates with a communication unit of the traffic flow control apparatus, information related to a following vehicle that travels between the first controlled vehicle and a second controlled vehicle that travels behind the first controlled vehicle and communicates with the communication unit, and information related to a forward object that is positioned ahead of the first controlled vehicle; and
causing the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.

20. A traffic flow control method comprising:
acquiring information related to a first controlled vehicle that communicates with a communication unit, information related to a following vehicle that travels between the first controlled vehicle and a second controlled vehicle that travels behind the first controlled vehicle and communicates with the communication unit, and information related to a forward object that is positioned ahead of the first controlled vehicle; and
causing the first controlled vehicle to behave based on energy consumption of the first controlled vehicle and of the following vehicle in relation to behavior of the first controlled vehicle, the energy consumption being acquired from the information related to the first controlled vehicle, the information related to the following vehicle, and the information related to the forward object.
